(19) United States
(12) Patent Application Publication
(10) Pub. No.: US 2002/0076995 A1
(43) Pub. Date: Jun. 20, 2002

(54) Connector

(75) Inventors: Naoya Kurimoto, Yokkaichi-city (JP); Kazuhiko Nimura, Yokkaichi-city (JP)

Correspondence Address: GREENBLUM & BERNSTEIN, P.L.C., 1941 ROLAND CLARKE PLACE, RESTON, VA, 20191, US

(73) Assignee: SUMITOMO WIRING SYSTEMS, LTD, Yokkaichi-city (JP)

(21) Appl. No.: 10/021,078

(22) Filed: Dec. 19, 2001

(30) Foreign Application Priority Data
Dec. 20, 2000 (JP) 2000-387719
Dec. 28, 2000 (JP) 2000-401434
Dec. 28, 2000 (JP) 2000-401956

(51) Int. Cl. H01R 13/514

(52) U.S. Cl. 439/752

(57) ABSTRACT

A retainer is mounted in housing in which chambers are formed, to be inserted from the side. A front stop plate provided in the front of the chambers is integrally formed with the retainer and includes a wrinkled surface. Female terminal fittings are inserted in the chambers a temporary locking position, and the surface of the front stop plate is touched so that the retainer is moved to a final locking position. A projection is fitted in a hooked groove and the retainer is further locked.

### BACKGROUND OF THE INVENTION

1. Field of the Invention

The present invention relates to a connector and in particular to connector with a retainer, and to a waterproof connector.

2. Description of the Related Art

A side retainer type connector is conventionally known. The side retainer type connector is a connector in which a retainer is inserted from the side and hooked onto the hooked portion of terminal fittings. Such a retainer can be placed at a temporary locking position so as to allow the insertion and extraction of the terminal fittings to the chambers, and at a final locking position so as to be locked with the terminal fittings.

Further, such a connector is disclosed in Japanese Patent Publication (Kokai) Hei No. 6-176815 etc.

However, a waterproof female connector, having a tower portion with chambers and surrounded by a hood, when the above-mentioned side type retainer is mounted on the tower portion, it is required that a jig be inserted in a narrow space between the tower portion and the hood, and the operation of moving the retainer between a temporary locking position and a final locking position is performed with the jig thus inserted. Therefore, the operation is troublesome.

There are many waterproof connectors which are equipped with a connector housing having a hood. But in this kind of connector, when the connector is small in size and includes many minute parts, the connector is formed by separately producing a housing with chambers and a hood, and then assembling the parts. This kind of two piece connector is disclosed in Japanese Patent Publication (Kokai) No. 2000-208195. In this kind of waterproof connector, a collective rubber stopper is known in order to simplify the seal structure of chambers (Japanese Patent Publication (Kokai) Hei No. 7-282892). The collective rubber stopper is sized to cover all of the chambers, has a form in which electric wire receiving holes are open at every position corresponding to a chamber and is mounted at the rear face of a housing. Further, terminal fittings are inserted in the chambers while expanding the electric wire receiving holes, and the inlet side of the chambers is closed by sealing the inner periphery of the electric wire receiving holes on the electric wires.

When the rubber stopper is applied to a two piece connector as described above, four parts, including a housing, a hood, a collective rubber stopper and a stop plate (not including terminal fittings and electric wires), are required. It has been desired to further reduce the number of parts in order to reduce costs.

A connector in which a retainer which functions to stop the slip of terminal fittings is assembled with a connector housing which houses the terminal fittings is conventionally known. In this case, when a front type retainer is mounted on a male connector housing, it is difficult to judge whether the retainer is properly mounted because the mounting position of the retainer is located on the inner side of the hood. Therefore, a procedure for visually and easily recognizing whether the retainer is properly mounted is obtained by changing the colors of the connector housing and the retainer.

However, since the connector housing and the retainer must be molded by separate resin materials in the conventional method to produce different colors, there has been a problem that production costs are high.

Further, recently, a connector obtained by a method called in-mold assembly by which a connector housing and a retainer are molded by the same mold and the retainer is temporarily assembled with the connector housing has become popular. However, it is difficult to mold the housing and the retainer in different colors by this method, and it is difficult to visually confirm whether the retainer is properly mounted in the connector obtained by the in-mold assembly method.

### SUMMARY OF THE INVENTION

The present invention was developed based on the above-mentioned circumstances. One of the purposes of the present invention is to easily perform the moving operation of a retainer.

Another purpose of the present invention is to inexpensively provide a connector in which it is easy to confirm whether the retainer is properly mounted on the housing.

According to an aspect of the present invention, the front stop plate at the front face of the connector housing is unitarily formed, a finger may be touched on the front stop plate, and the moving operation of the retainer can be easily performed without using a jig.

According to a further aspect of the present invention, since the wrinkled face is formed on the surface of the front stop plate, the wrinkles prevent finger sliding, and the retainer may be more smoothly moved.

According to an aspect of the present invention, a connector is provided including a connector housing having a plurality of chambers therein in which terminal fittings are provided, a retainer for preventing movement of the terminal fittings, the retainer being received in a front end of the connector housing and configured to be retained in the connector housing at a temporary locking position allowing insertion and extraction of the terminal fittings into and out of the chambers and a final locking position preventing movement of the terminal fittings within the chambers, and a front stop plate configured to prevent movement of the terminal fittings within the chambers when the retainer is positioned in the final locking position, the front stop plate being formed unitarily and in one piece with the retainer. The front stop plate may also include a wrinkled surface.

According to a further aspect of the present invention, a plurality of temporary locking strips is provided on an upper face and a lower face of the connector housing and extending from the front end toward a rear end of the connector housing, a plurality of final locking strips is provided on the upper face and the lower face of the connector housing and extending from the front end toward the rear end of the connector housing, and a plurality of locking grooves is provided on an upper face and a lower face inside the retainer and extending from a front end toward a rear end of the retainer, wherein the plurality of locking grooves can be fitted to the plurality of temporary locking strips to position the retainer in the temporary locking position, the plurality of locking grooves can be fitted to the plurality of final locking strips to position the retainer in the final locking position, and the retainer can be moved relative to the connector housing in a transverse direction between the temporary locking position and the final locking position.

In another aspect of the present invention, a plurality of projections is provided on a ceiling wall plate and a bottom wall plate in the retainer, wherein the plurality of projections are offset to corresponding chambers in the connector housing when the retainer is positioned in the temporary locking position, the plurality of projections extend into the chambers in the connector housing and grooves in the terminal fittings therein when the retainer is positioned in the final locking position, and the retainer can be moved relative to the connector housing in a transverse direction between the temporary locking position and the final locking position. The connector may further include a plurality of lances provided on the inside of the connector housing, the plurality of lances extending toward the front face of the connector housing and being configured to be elastically bent into bending spaces adjacent the lances and hooked onto barb portions of the terminal fittings, and a plurality of insert portions provided on the retainer and extending toward a rear end of the retainer, the insert portions being configured to extend into the bending spaces.

According to a further aspect of the present invention, a method of assembling a connector is provided including providing a connector housing having a plurality of chambers for receiving terminal fittings therein, providing a retainer for preventing movement of the terminal fittings, assembling the retainer and the connector housing such that the retainer is received in a front end of the connector housing and the retainer may be retained in the connector housing at a temporary locking position allowing insertion and extraction of the terminal fittings into and out of the chambers and a final locking position preventing movement of the terminal fittings within the chambers, and providing a front stop plate, the front stop plate configured to prevent movement of the terminal fittings within the chambers when the retainer is positioned in the final locking position, the front stop plate being formed unitarily and in one piece with the retainer.

According to another aspect of the present invention, the method may further include providing a plurality of temporary locking strips on an upper face and a lower face of the connector housing and extending from the front end toward a rear end of the connector housing, providing a plurality of final locking strips on the upper face and the lower face of the connector housing and extending from the front end toward the rear end of the connector housing, providing a plurality of locking grooves on an upper face and a lower face inside the retainer and extending from a front end toward a rear end of the retainer, wherein the plurality of locking grooves can be fitted to the plurality of temporary locking strips to position the retainer in the temporary locking position, and the plurality of locking grooves can be fitted to the plurality of final locking strips to position the retainer in the final locking position, and moving the retainer relative to the connector housing in a transverse direction between the temporary locking position and the final locking position. The method of the present invention may further include providing a plurality of projections on a ceiling wall plate and a bottom wall plate in the retainer, wherein the plurality of projections are offset to corresponding chambers in the connector housing when the retainer is positioned in the temporary locking position, and the plurality of projections extend into the chambers in the connector housing and grooves in the terminal fittings therein when the retainer is positioned in the final locking position, and moving the retainer relative to the connector housing in a transverse direction between the temporary locking position and the final locking position. The method may further include providing a plurality of lances on the inside of the connector housing, the plurality of lances extending toward the front face of the connector housing and being configured to be elastically bent into bending spaces adjacent the lances and hooked onto barb portions of the terminal fittings, providing a plurality of insert portions on the retainer extending toward a rear end of the retainer, and assembling the retainer and the connector housing may include inserting the terminal fittings into the chambers, thereby bending the lances into the bending spaces, and inserting the insert portions into the bending spaces.

According to a further aspect of the present invention, the plurality of insert portions may be offset to corresponding chambers in the connector housing when the retainer is positioned in the temporary locking position, and the plurality of insert portions may extend into the bending spaces when the retainer is positioned in the final locking position, the method may further include moving the retainer relative to the connector housing in a transverse direction between the temporary locking position and the final locking position, thereby inserting the plurality of insert portions into corresponding the bending spaces.

In a further aspect of the present invention, a waterproof connector is provided including a connector housing having a plurality of chambers in which terminal fittings are provided, a hood, the hood being assembled with the connector housing and covering an outer surface thereof, a stopper storing recess provided at a rear face of the connector housing, the stopper storing recess configured to receive a collective stopper, a collective stopper mounted in the stopper storing recess over the rear face of the connector housing and covering the plurality of chambers, and a rear stop plate provided on the hood, the rear stop plate being configured to press the collective stopper. The waterproof connector may further include a retainer for preventing movement of terminal fittings inserted in the chambers, the retainer being mounted in a front end of the connector housing and being configured to be retained in the connector housing at a temporary locking position allowing insertion and extraction of the terminal fittings into and out of the chambers and a final locking position preventing movement of the terminal fittings within the chambers.

According to a further aspect of the present invention, a connector is provided including a connector housing configured to receive terminal fittings, a retainer configured to stop movement of terminal fittings within the connector housing, the retainer being assembled with the connector housing, and a wrinkled molding provided on the surface of one of the connector housing and the retainer. The connector housing may further include a plurality of chambers to receive the terminal fittings, and wherein the retainer is configured to be retained in the connector housing at a temporary locking position allowing insertion and extraction of the terminal fittings into and out of the connector housing and a final locking position preventing movement of the terminal fittings.

In a further aspect of the present invention, the connector housing and the retainer are molded in one mold such that the retainer may be removed by a moving mechanism from the mold in a condition in which it is assembled with the connector housing in the temporary locking position. The retainer may be received in a front end of the connector housing, and the connector may further include a plurality of lances provided on the inside of the connector housing, the plurality of lances extending toward the front face of the connector housing and being configured to be elastically bent into bending spaces adjacent the lances and hooked onto barb portions of the terminal fittings, and a plurality of insert portions provided on the retainer and extending toward a rear end of the retainer, the insert portions being configured to extend into the bending spaces. The connector housing may further include a tower portion including a plurality of chambers therein, each chamber of the plurality of chambers configured to receive a male terminal fitting therein, and a hood portion configured to receive the retainer therein.

According to another aspect of the present invention, the connector may further include a plurality of chambers provided in the connector housing, the chambers configured to receive terminal fittings therein, and the retainer being received in a front end of the connector housing and configured to be retained in the connector housing in a temporary locking position allowing insertion and extraction of the terminal fittings into and out of the chambers and a final locking position preventing movement of the terminal fittings within the chambers. Further, the connector may include a plurality of temporary locking projections provided on the inside of the retainer and extending from a rear end of the retainer toward a rear end of the retainer, a plurality of final locking projections provided on the inside of the retainer and extending transversely from the sides of the retainer, a plurality of sliding grooves provided on the inside of the plurality of chambers in the connector housing and extending from a front end of the connector housing toward a rear end of the connector housing and a plurality of locking parts provided at a rear end of the sliding grooves, and a plurality of guide grooves provided on the inside of the plurality of chambers in the connector housing and extending from a front end of the connector housing toward a rear end of the connector housing and a plurality of locking rims provided at a rear end of the guide grooves, wherein the plurality of temporary locking projections can be locked onto corresponding locking parts to position the retainer in the temporary locking position, and the plurality of final locking projections can be locked onto corresponding the locking rims to position the retainer in the final locking position, and the retainer can be moved relative to the connector housing in a forward direction between the temporary locking position and the final locking position. The connector may include a plurality of lances provided on the inside of the connector housing, the plurality of lances extending toward the front face of the connector housing and being configured to be elastically bent into bending spaces adjacent the lances and hooked onto barb portions of the terminal fittings, and a plurality of insert portions provided on the retainer and extending toward a rear end of the retainer, the insert portions being configured to extend into the bending spaces when the retainer is positioned in the final locking position.

According to a further aspect of the present invention, a method of assembling a connector is provided including providing a connector housing configured to receive terminal fittings, providing a retainer configured to prevent movement of terminal fittings within the connector housing, assembling the retainer with the connector housing, and providing a wrinkled molding on the surface of one of the connector housing and the retainer. The connector housing may further include a plurality of chambers to receive the terminal fittings, and wherein the retainer may be configured to be retained in the connector housing at a temporary locking position allowing insertion and extraction of the terminal fittings into and out of the connector housing and a final locking position preventing movement of the terminal fittings. The method may further include molding the connector housing and the retainer in one mold such that the retainer may be removed by a moving mechanism from the mold in a condition in which the retainer is assembled with the connector housing in the temporary locking position.

According to a further aspect of the present invention, the method of assembling a connector may further include providing a plurality of lances on the inside of the connector housing, the plurality of lances extending toward the front face of the connector housing and being configured to be elastically bent into bending spaces adjacent the lances and hooked onto barb portions of the terminal fittings, and providing a plurality of insert portions on the retainer and extending toward a rear end of the retainer, the insert portions being configured to extend into the bending spaces; and the connector housing may further include a tower portion including a plurality of chambers therein, each chamber of the plurality of chambers configured to receive a male terminal fitting therein, and a hood portion configured to receive the retainer therein. The method may further include providing a plurality of chambers in the connector housing, the chambers configured to receive terminal fittings therein, and the retainer being received in a front end of the connector housing and configured to be retained in the connector housing in a temporary locking position allowing insertion and extraction of the terminal fittings into and out of the chambers and a final locking position preventing movement of the terminal fittings within the chambers.

In a further aspect of the present invention, the method may include providing a plurality of temporary locking projections on the inside of the retainer and extending from a front end of the retainer toward a rear end of the retainer, providing a plurality of final locking projections on the inside of the retainer and extending transversely from the sides of the retainer, providing a plurality of sliding grooves on the inside of the plurality of chambers in the connector housing and extending from a front end of the connector housing toward a rear end of the connector housing and a plurality of locking parts provided at a rear end of the sliding grooves, and providing a plurality of guide grooves on the inside of the plurality of chambers in the connector housing and extending from a front end of the connector housing toward a rear end of the connector housing and a plurality of locking rims provided at a rear end of the guide grooves, wherein the plurality of temporary locking projections can be locked onto corresponding locking parts to position the retainer in the temporary locking position, and the plurality of final locking projections can be locked onto corresponding the locking rims to position the retainer in the final locking position, and the retainer can be moved relative to the connector housing in a forward direction between the temporary locking position and the final locking position. The method of assembling a connector may further include providing a plurality of lances on the inside of the connector housing, the plurality of lances extending toward the front face of the connector housing and being configured to be elastically bent into bending spaces adjacent the lances and hooked onto barb portions of the terminal fittings, and providing a plurality of insert portions on the retainer and extending toward a rear end of the retainer, the insert portions being configured to extend into the bending spaces when the retainer is positioned in the final locking position.

### BRIEF DESCRIPTION OF THE DRAWINGS

The above and other objects, features and advantages of the present invention will be made apparent from the following description of the preferred embodiments, given as non-limiting examples, with reference to the accompanying drawings in which:

FIG. 1 is an exploded sectional view of an embodiment of the present invention;

FIG. 2 is a sectional side view of a female terminal fitting;

FIG. 3 is a front view of the female terminal fitting of FIG. 2;

FIG. 4 is a side view of a female terminal housing of the present invention;

FIG. 5 is a plan view of the housing of FIG. 4;

FIG. 6 is a sectional plan view of the housing of FIG. 4;

FIG. 7 is a rear view of the housing of FIG. 4;

FIG. 8 is a front view of the housing of FIG. 4;

FIG. 9 is a sectional front view of the housing of FIG. 4;

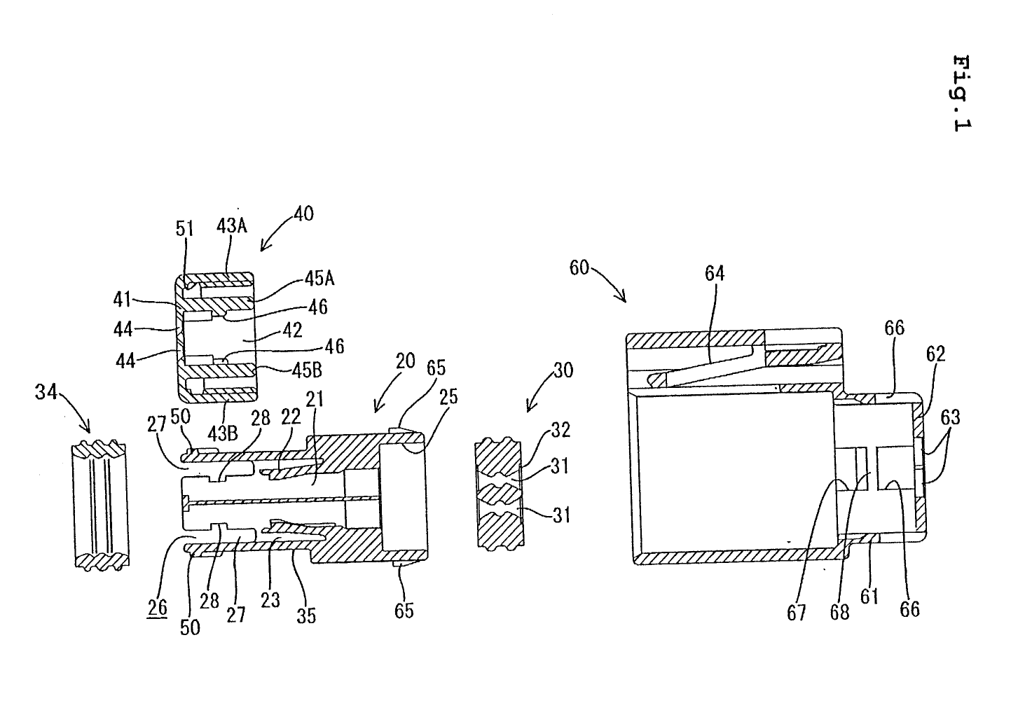

FIG. 1O is a front view of a stopper of the present invention;

FIG. 11 is a front view of a retainer of the present invention;

FIG. 12 is a rear view of the retainer of FIG. 11;

FIG. 13 is a front view of a hood of the present invention;

FIG. 14 is a rear view of the hood of FIG. 13;

FIG. 15 is a sectional side view prior to assembly of a housing with a hood;

FIG. 16 is a sectional side view prior to insertion of female terminal fittings;

FIG. 17 is a side view of a housing inserted in a hood;

FIG. 18 is a rear view of the housing inserted in the hood of FIG. 17;

FIG. 19 is a sectional side view showing performance of a continuity test;

FIG. 20 is a front view of a retainer situated at a temporary locking position;

FIG. 21 is a front view of a retainer situated at a final locking position;

FIG. 22 is a front view of a housing of the second embodiment of the present invention;

FIG. 23 is a plan view of the housing of FIG. 22;

FIG. 24 is a left side view of the housing of FIG. 22;

FIG. 25 is a sectional side view of the housing of FIG. 22;

FIG. 26 is a front view of a retainer of the second embodiment of the present invention;

FIG. 27 is a plan view of the retainer of FIG. 26;

FIG. 28 is a right side view of the retainer of FIG. 26;

FIG. 29 is a front view of the retainer of FIG. 26 situated at a temporary locking position;

FIG. 30 is a left side view of the retainer of FIG. 26 situated at a temporary locking position;

FIG. 31 is a sectional view of the retainer of FIG. 26 situated at a temporary locking position;

FIG. 32 is a sectional view prior to insertion of female terminal fittings;

FIG. 33 is a front view of the retainer of FIG. 26 situated at a final locking position;

FIG. 34 is a sectional view of the retainer of FIG. 26 situated at a final locking position; and

FIG. 35 is a sectional side view of the retainer of FIG. 26 situated at a final locking position.

FIG. 36 is an exploded perspective view of a connector of a third embodiment of the present invention;

FIG. 37 is an exploded sectional view of the connector of FIG. 36;

FIG. 38 is a front view of a retainer situated at temporary locking position, of the connector of FIG. 36;

FIG. 39 is a sectional view of the connector of FIG. 36 and showing the insertion of male terminal fittings;

FIG. 40 is a sectional view of the connector of FIG. 36 and showing male terminal fittings inserted therein; and

FIG. 41 is a sectional view of the connector of FIG. 36 and showing a retainer situated in a final locking position.

### DETAILED DESCRIPTION OF THE PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

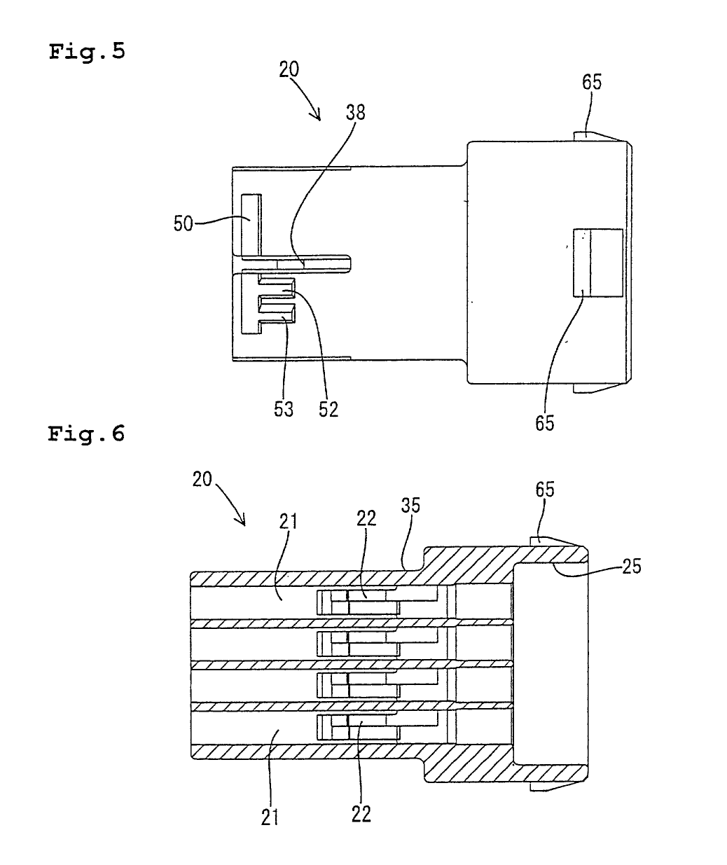

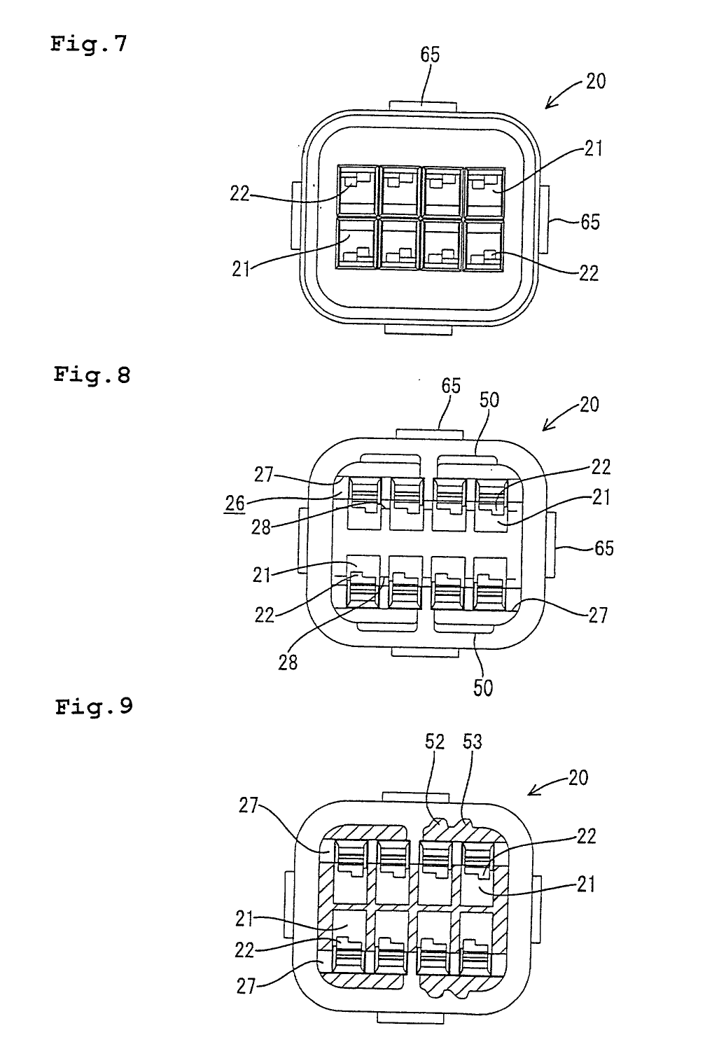

The present invention is described below with reference to the first embodiment shown in FIG. 1 to FIG. 21.

As shown in FIG. 1, the waterproof female connector includes a housing 20, a hood 60, a packing 34 which seals a gap between a corresponding male connector, a collective stopper 30, and a retainer 40 which secondarily locks the female terminal fittings 10 mounted in the housing 20.

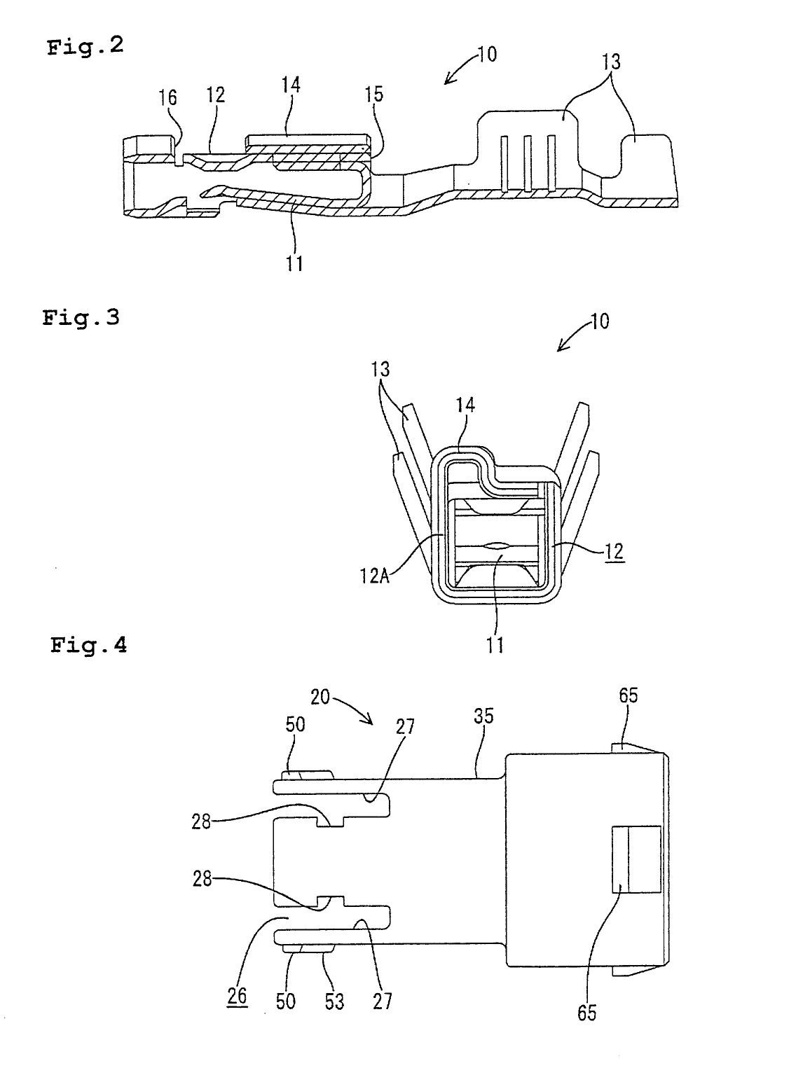

As shown in FIGS. 2, 3, 16 and 19, the female terminal fittings 10 have substantially square tubular connecting portions 12 which are configured to receive tab connecting portions of corresponding male terminal fittings therein. Elastic connecting pieces 11 elastically grip tab connecting portions received in the tubular connecting portions 12. Female terminal fittings 10 are fixed on the terminal ends of electric wires W by crimping barrels 13 which are provided at the rear end thereof. The stabilizers 14 which protrude upwardly are formed at one side of the upper face of the connecting portions 12, and the lances 22 of housing 20 can be hooked on the barb portions 15 of the rear rim at the same level. Further, the hooked groove 16 on which the projection 46 of the retainer 40 can be fitted is formed at the side edge position at the same level by being opened at the side face.

The housing 20 may be formed of any suitable material, such as a synthetic resin, formed in a block form which is slightly larger at the rear end as shown in FIG. 4 to FIG. 9. The chambers 21 store the above-mentioned female terminal fittings 10 and open on the front and rear faces of housing 20 in two levels which each contain four chambers. The chambers 21 are symmetrically formed facing in opposite directions on the top and bottom levels. The lances 22 are respectively provided in a condition in which they can be elastically bent toward the upper face in the upper level of chambers 21, and toward the bottom face in the lower level of chambers 21, facing toward the bending space 23 as shown in FIG. 1.

The collective stopper 30, which may be formed of any suitable material, such as rubber, is configured to be mounted in the rear face of the housing 20. As shown in FIG. 10, the stopper 30 is formed in a substantially square form which can cover the inlets of all of the chambers 21. The electric wire insertion holes 31 through which the electric wires W can pass are formed in the stopper 30 in correspondence with the arrangement of the chambers 21.

Further, the marks 32 which match in location with the stabilizers 14 provided on the female terminal fittings 10, are formed at the entrance rims of the electric wire insertion holes 31. As shown in FIG. 10, the marks 32 are at the right upper position for the electric wire insertion holes 31 of the upper level, and at the left lower position for the electric wire insertion holes 31 of the lower level. Further, the marks 32 are provided on both sides of stopper 30, and are formed so that the stopper 30 may be mounted facing either the inside or the outside.

Further, the stopper storing recess 25 which snugly fits with and fixes the stopper 30 is formed at the rear face of the housing 20 adjacent the rear inlets of the respective chambers 21.

The fitting position 35 of the packing 34 which seals between female housing 20 and the corresponding male housing (not illustrated) is positioned at the outer periphery in front of the step between the larger and smaller portions of the housing 20. The retainer 40 is configured to be mounted in front of the fitting position 35 of the packing 34. The retainer 40 may be formed of any suitable material, such as a synthetic resin material, and is provided with a front stop plate 41 which covers the front face of the front end part of the housing 20, a side plate 42 which covers the left side face as viewed from the front, and an upper face plate 43A and a lower face plate 43B which cover the top and bottom faces as shown in FIGS. 1, 11 and 12. The front stop plate 41 functions to stop the female terminal fittings 10 inserted in the chambers 21 from extending out of the front ends of the chambers, while insertion openings 44 through which the tabs of the male terminal fittings may be inserted open at positions corresponding to the respective chambers 21.

A ceiling wall plate 45A and a bottom wall plate 45B, respectively constitute the front end part of the ceiling wall of the upper level chambers 21 and the front end part of the bottom wall of the lower level chambers 21. They are located a fixed distance from the upper face plate 43A and the lower face plate 43B and extend from the rear face of the front stop plate 41. Four projections 46 are formed at positions corresponding to the positions of the terminal insertion openings 44 at the midpoint of the inside face side of the ceiling wall plate 45A and the bottom wall plate 45B. The respective projections 46 can penetrate into the hooked grooves 16 of the female terminal fittings 10 from the side.

Retainer insertion holes 26, in which the above-mentioned retainer 40 is inserted, are formed at the front face of the housing 20. The retainer insertion holes 26 have top and bottom insertion grooves 27 which respectively receive the ceiling wall plate 45A and the bottom wall plate 45B of the retainer 40. The projection insertion grooves 28 can respectively receive the projections 46, and are formed in the lower face of the upper side insertion groove 27 and the upper face of the lower side insertion groove 27. Specifically, the respective projection insertion grooves 28 correspond to the configurations of the ceiling face of the upper level chambers 21 and the bottom face of the lower level chambers 21, namely, positions corresponding to the hooked grooves 16 when the female terminal fittings 10 are properly inserted.

As shown in FIG. 5, ribs 50 extending in the transverse direction are formed on the upper face and the lower face at the front end of the housing 20. As shown in FIG. 1, guide grooves 51 which receive the ribs 50 also extend in the transverse direction and are formed at the innermost position of retainer 40.

Accordingly, the retainer 40 maintains the front stop plate 41 along the front face of the housing 20, while the ceiling wall plate 45A and the bottom wall plate 45B pass through insertion grooves 27. The retainer 40 is configured to be inserted and mounted from the left side face as viewed from the front of the housing 20 (note FIG. 12), while the ribs 50 pass through the guide grooves 51. At this time, the projections 46 of the retainer 40 are inserted and passed through the projection insertion grooves 28.

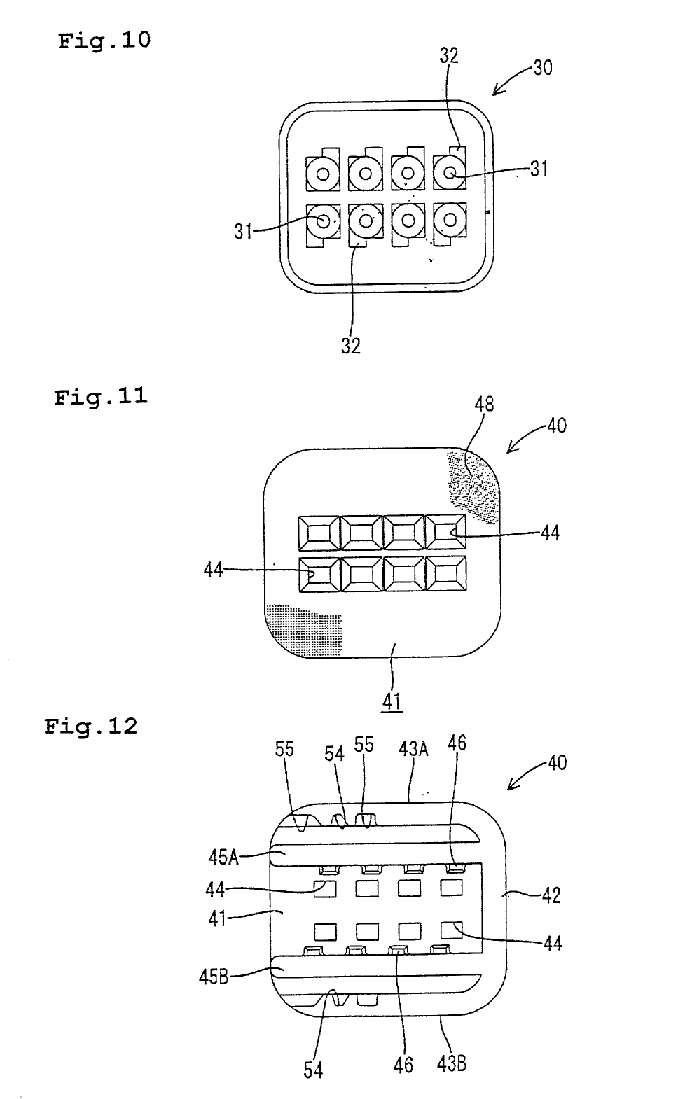

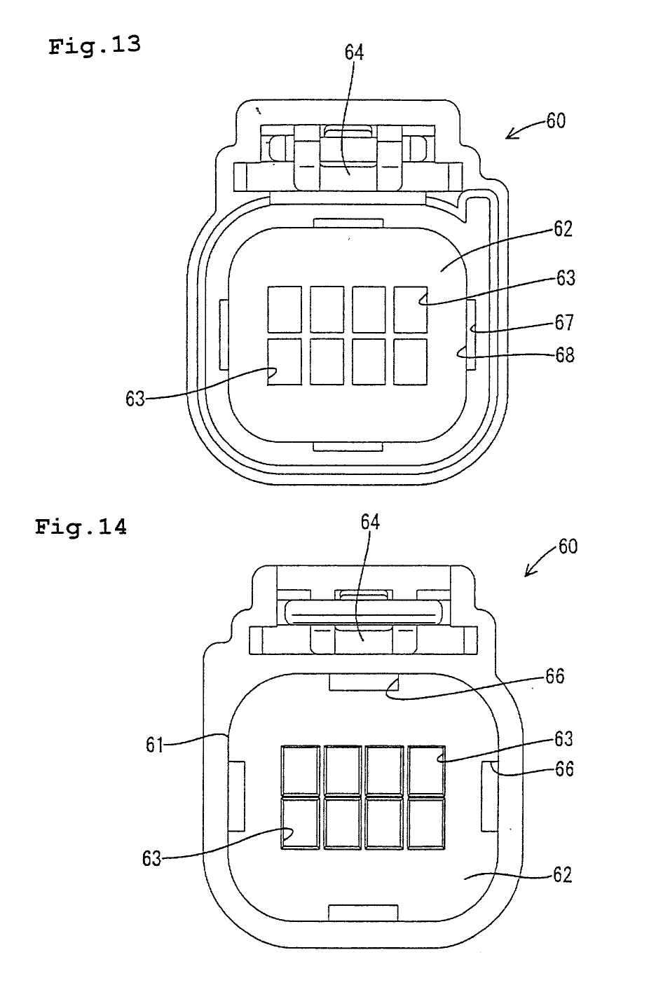

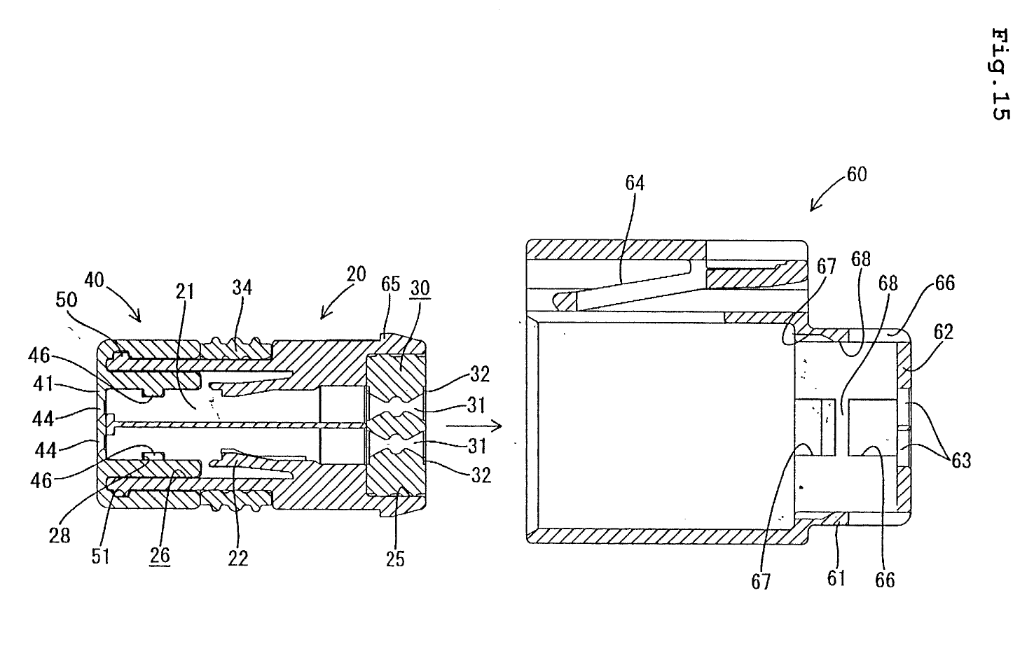

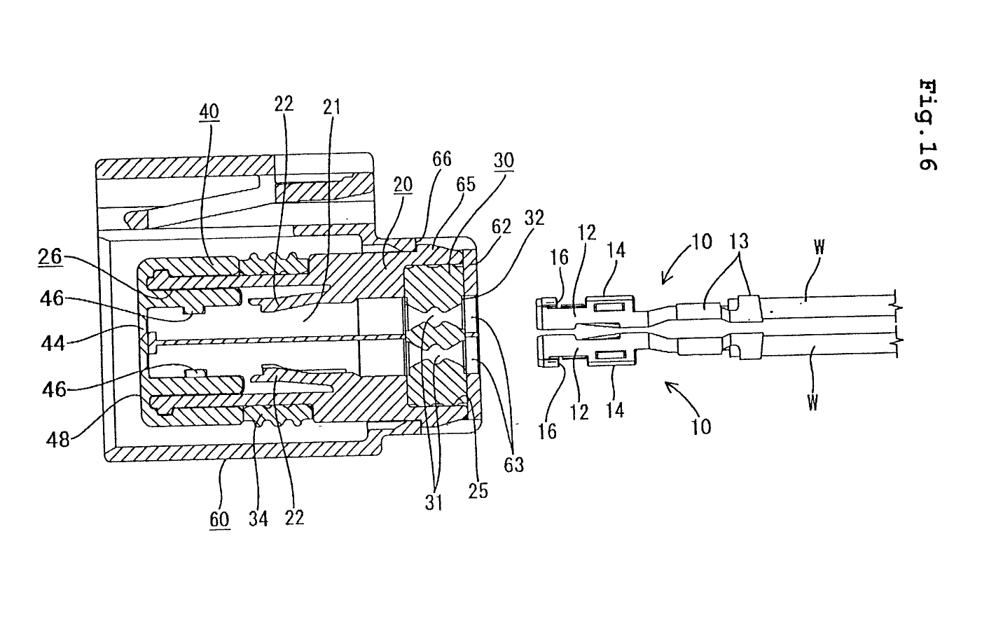

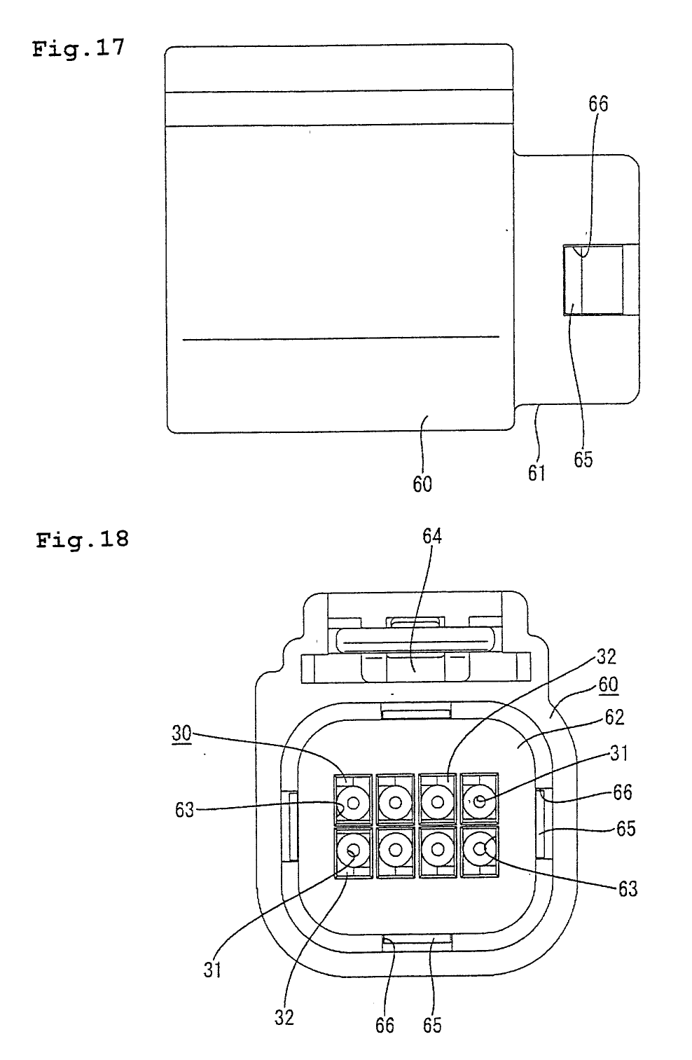

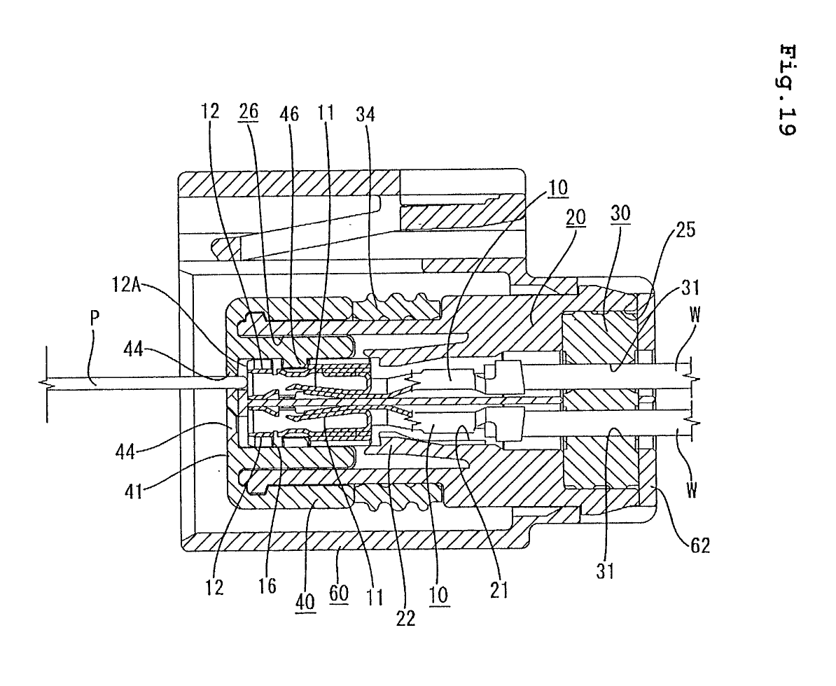

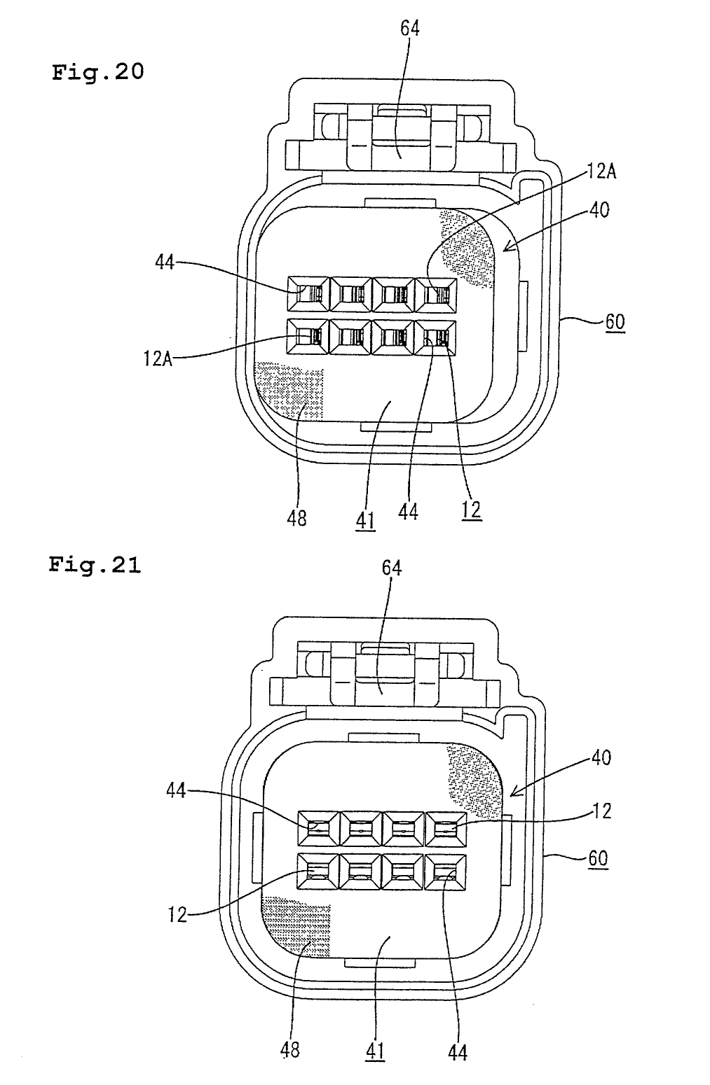

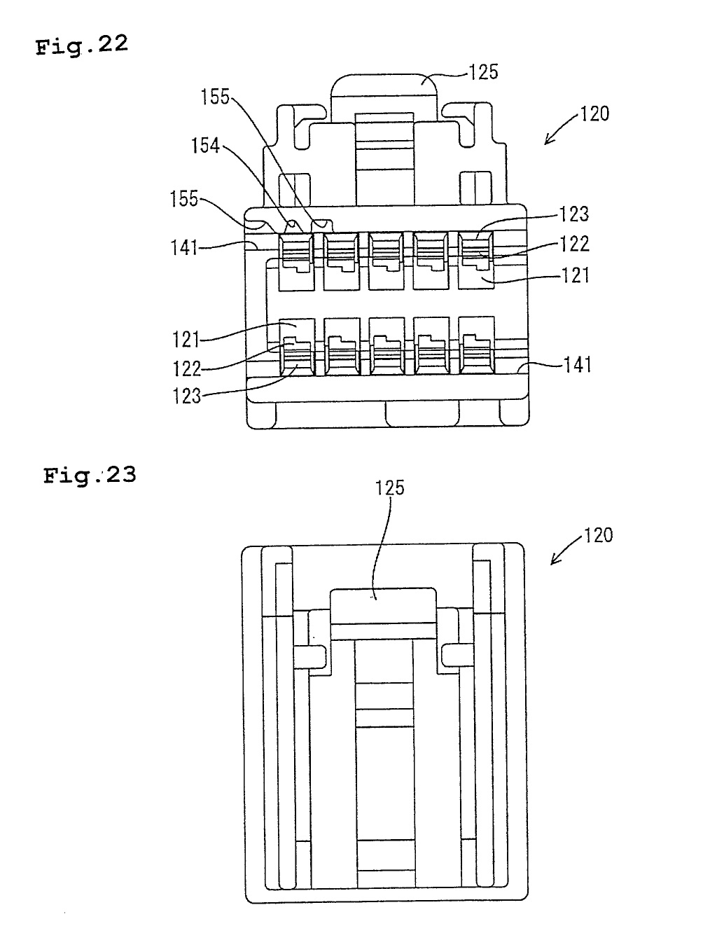

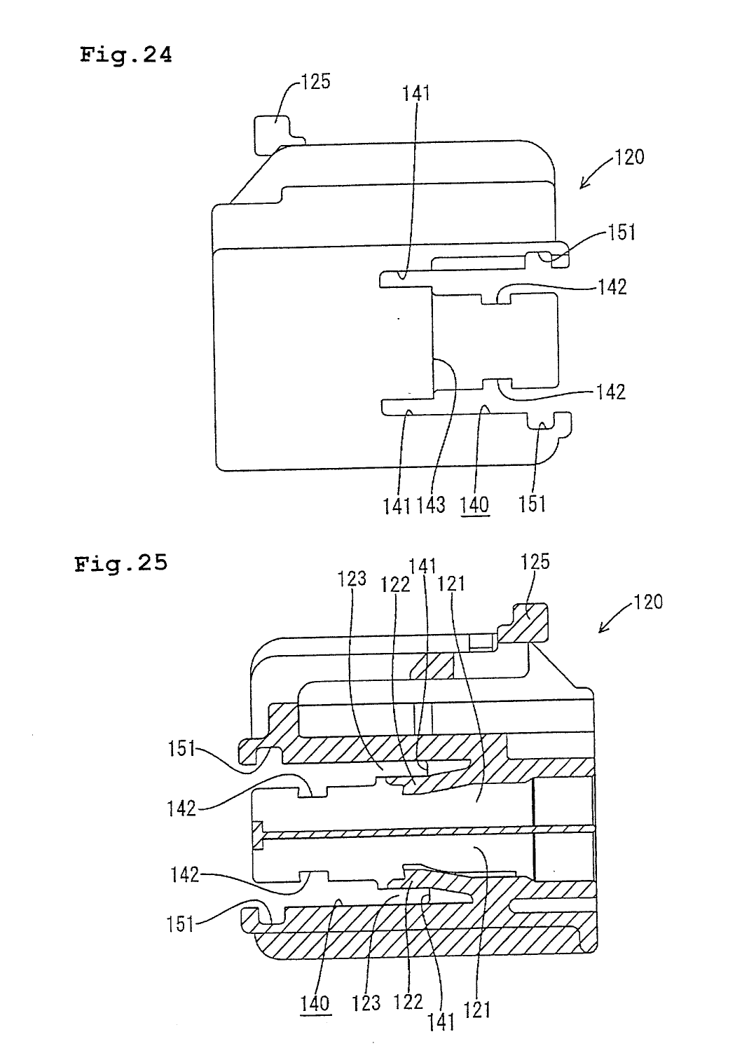

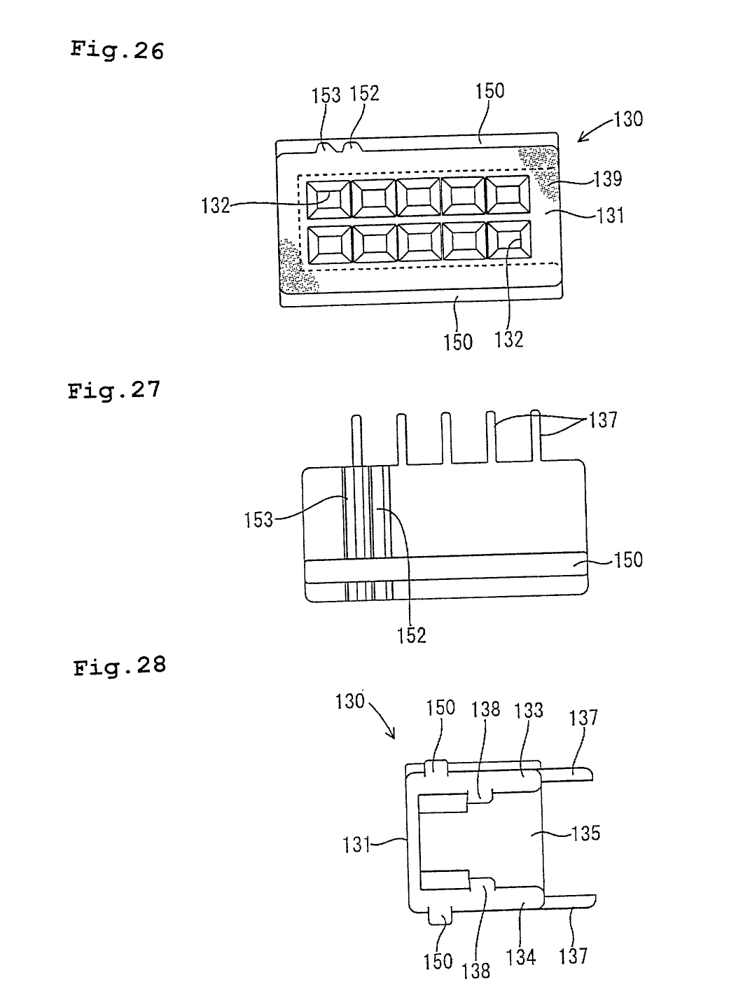

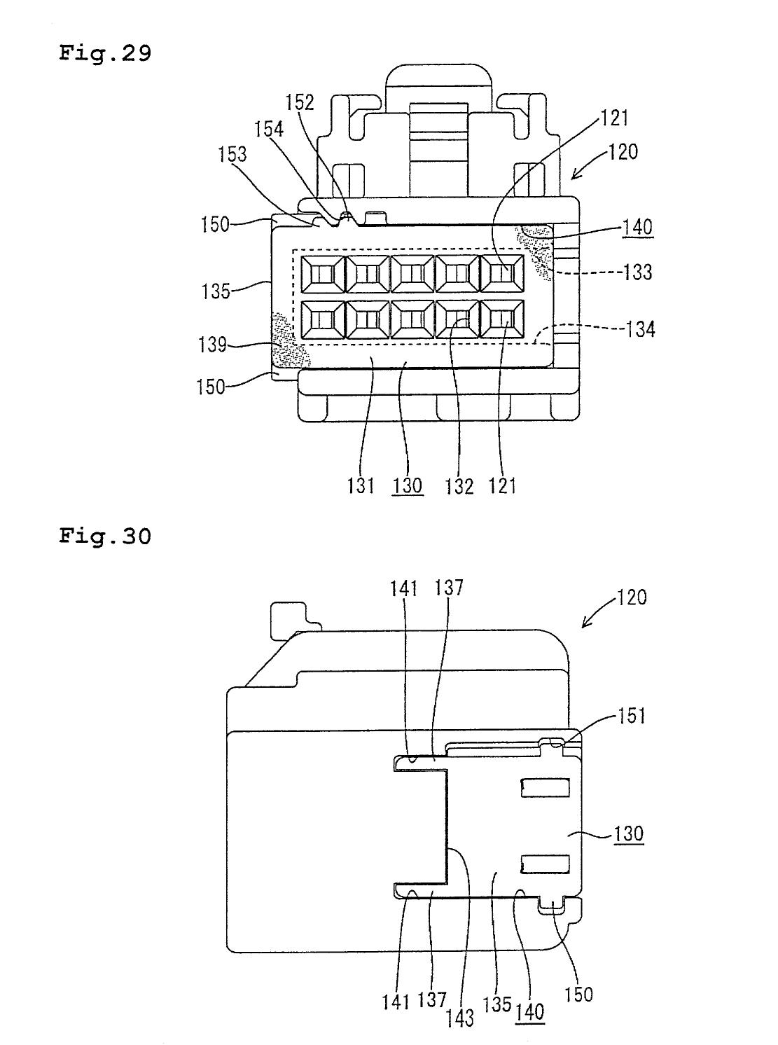

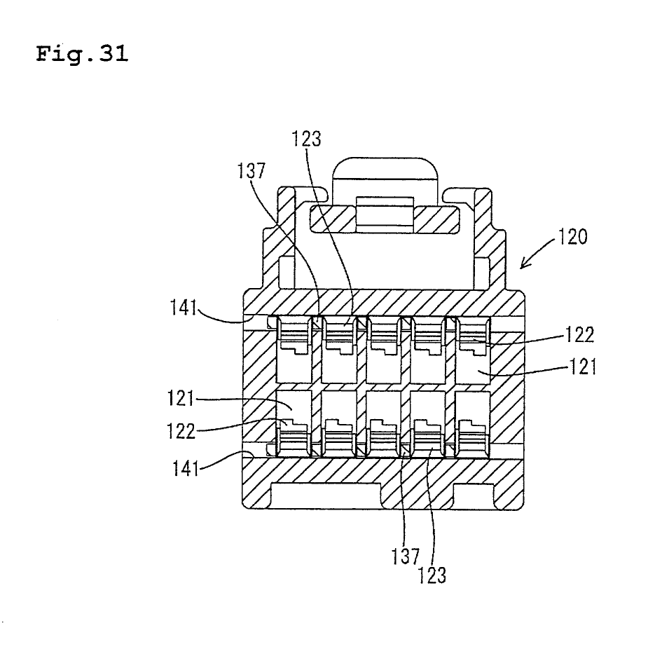

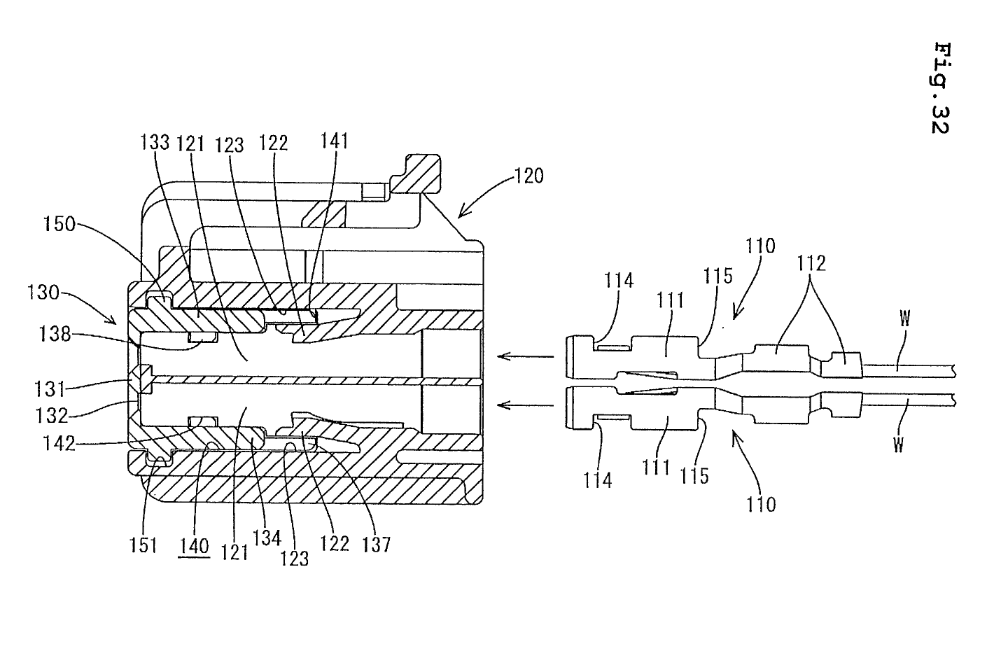

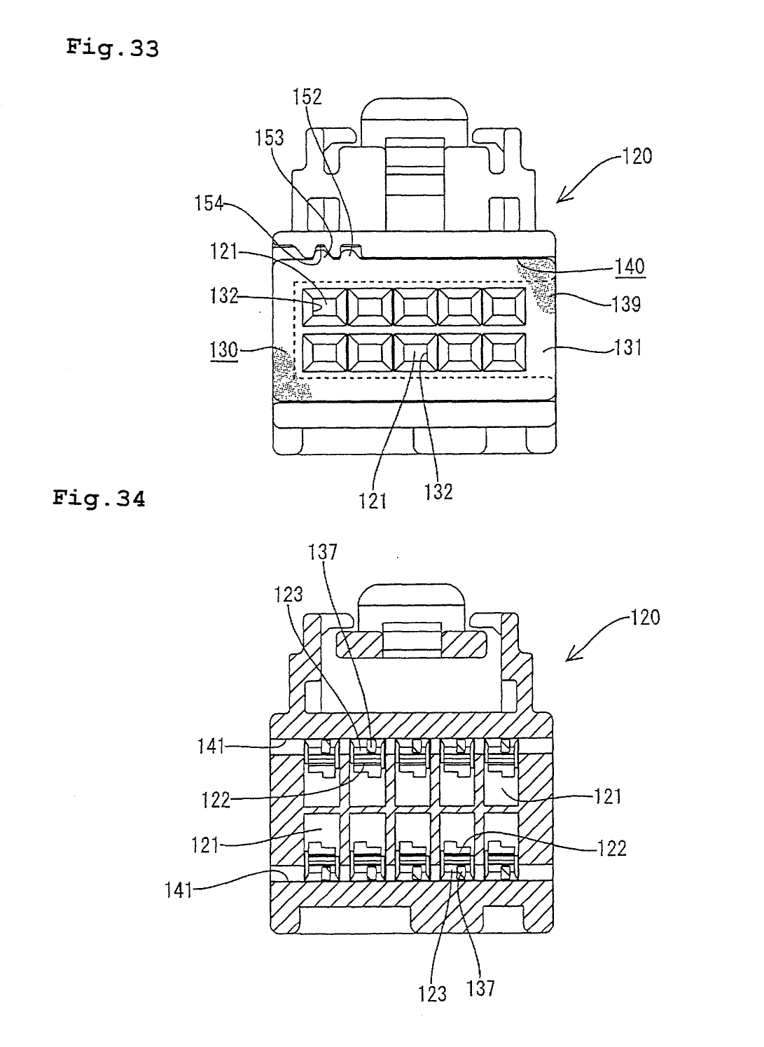

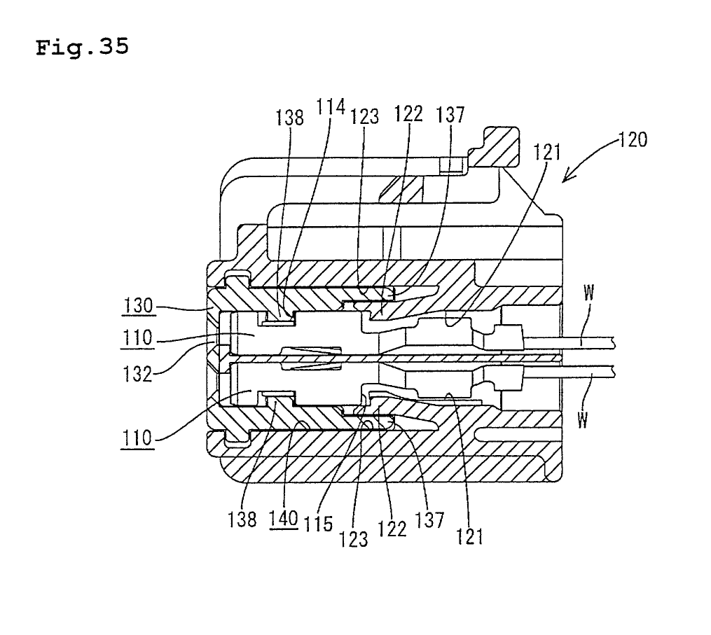

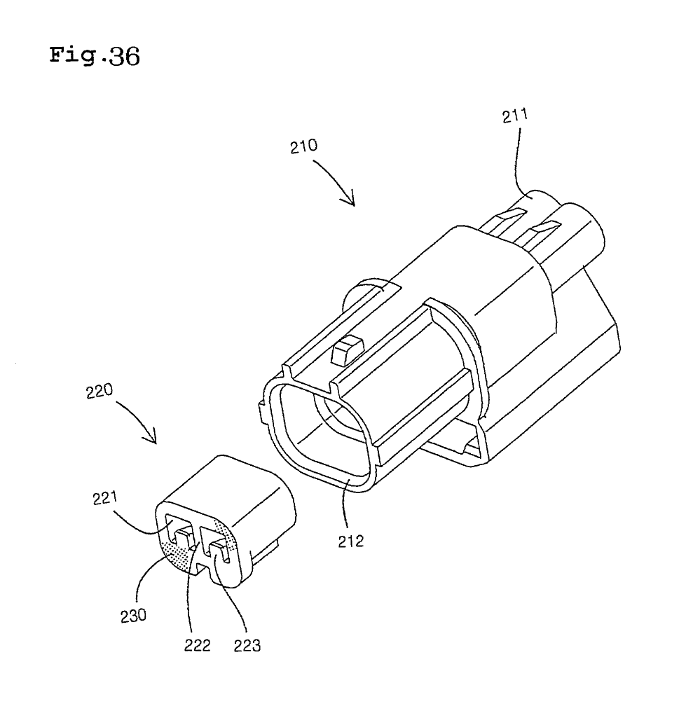

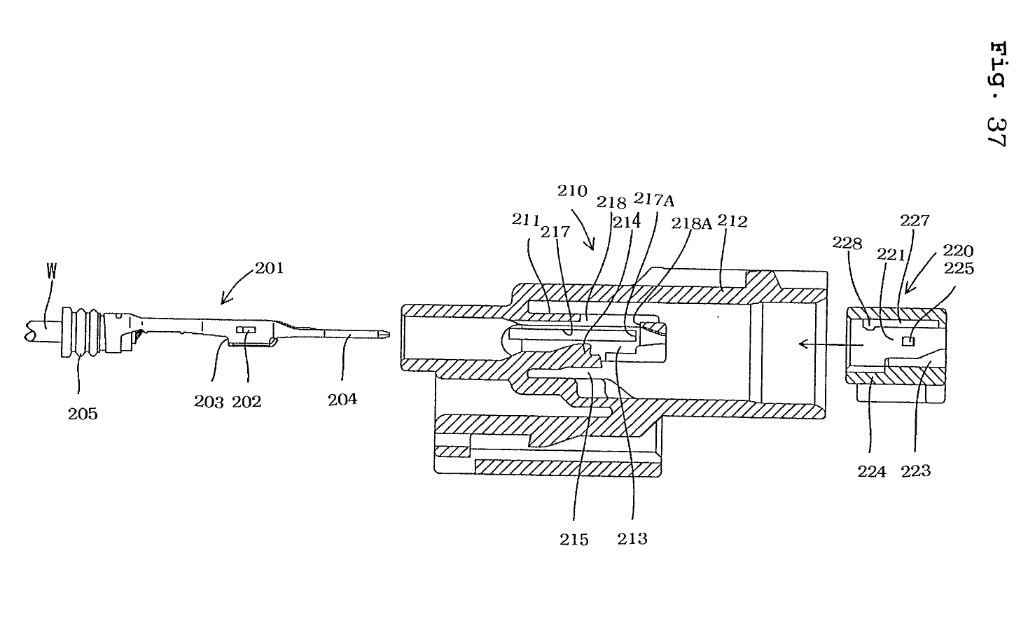

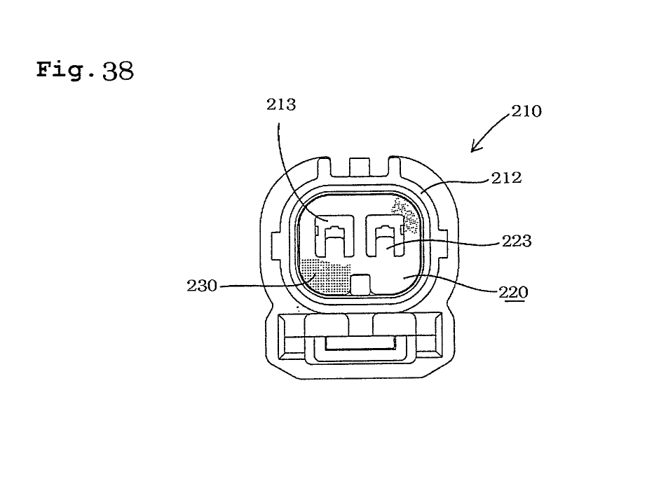

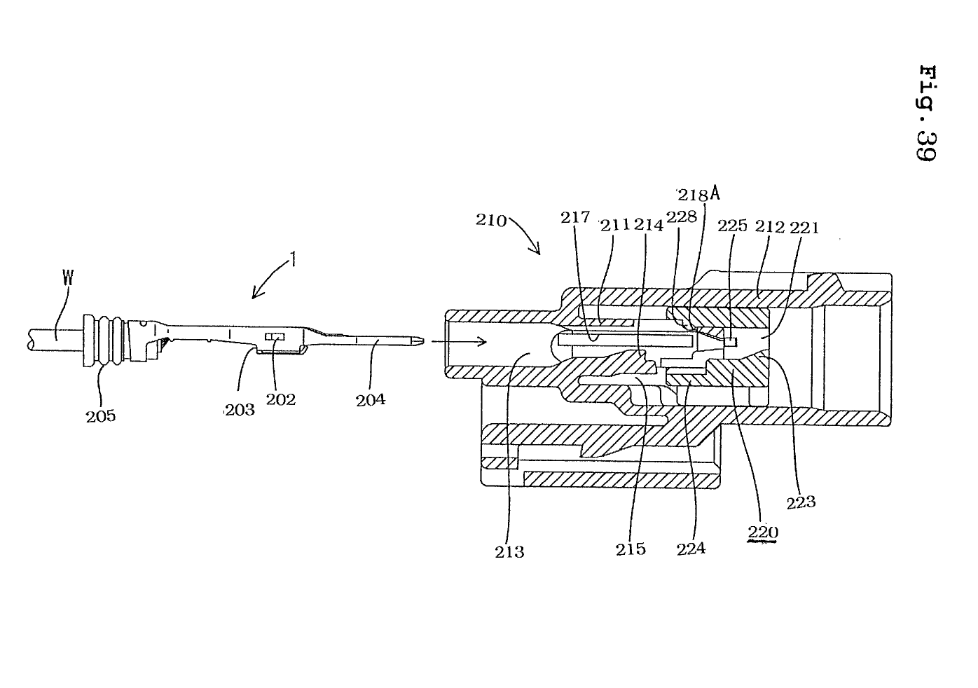

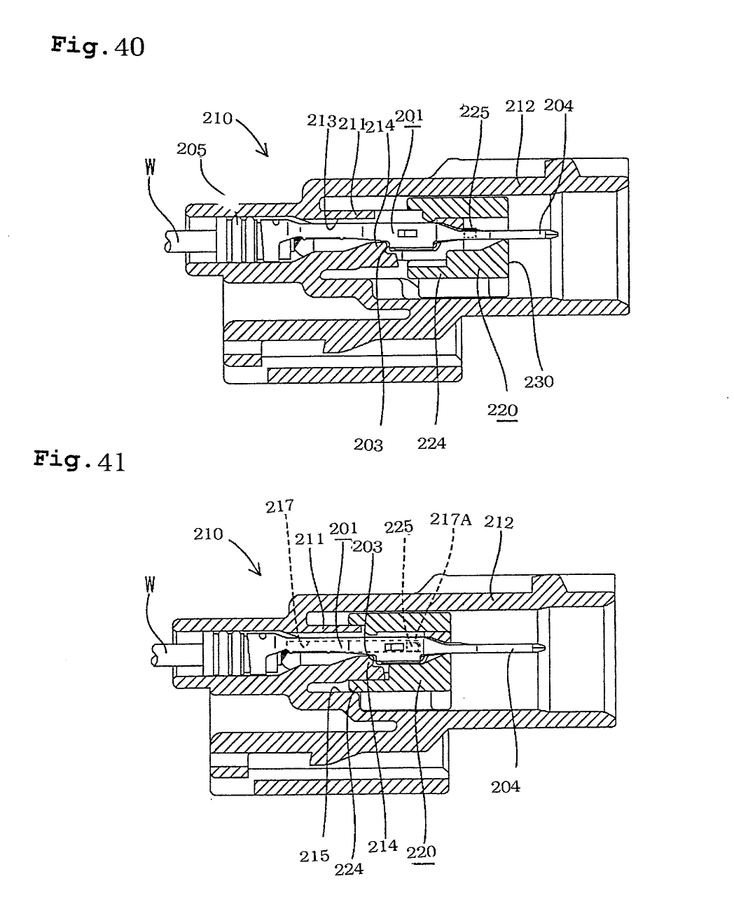

As shown in FIG. 5 and FIG. 9, temporary locking protrusion strips 52 and final locking protrusion strips 53 are provided on the upper face and the lower face of the housing 20 on the inside of the ribs 50 toward the right side as viewed from the front. On the other hand, the locking grooves 54 to which the above-mentioned temporary locking protrusion strips 52 and the final locking protrusion strips 53 can be fitted are formed at the right side as viewed from the front in the inner face of the upper face plate 43A and the lower face plate 43B of the retainer 40, as shown in FIG. 12. Further, escape grooves 55 which fit the temporary locking protrusion strips 52 and the final locking protrusion strips 53 to allow for escape are formed at both sides of the locking grooves 54.

When the retainer 40 is inserted in the retainer insertion hole 26, the temporary locking protrusion strips 52 are first fitted in the locking grooves 54, and retained at the temporary locking position, as shown in FIG. 20. When the retainer 40 is situated at the temporary locking position, each terminal insertion opening 44 of the front stop plate 41 is offset to the left side as shown in FIG. 20, and only the left side region of the front face of the corresponding chamber 21 is open. Further, the respective projections 46 are in a condition in which they are to the left side of the corresponding chambers 21.

Further, when the retainer 40 is pushed in from the temporary locking position to the final locking position, the final locking protrusion strips 53 are fitted in the locking groove 54, as shown in FIG. 21. In the final locking position, the left side plate 42 of the retainer 40 is in substantially the same plane as the left side face of the rear end part of the housing 20. Further, each terminal insertion opening 44 of the front stop plate 41 aligns with the front face of the corresponding chamber 21, and each of the projections 46 penetrates into the corresponding chamber 21.

Further, as shown in FIG. 11, a wrinkled face 48 is formed on the surface of the front stop plate 41 of the retainer 40. The wrinkled face 48 indicates an uneven rough face. The wrinkled face 48 is formed, for example, by forming a wrinkled pattern on the molding face of a mold on which the surface of the front stop plate 41 is molded, in the mold for the retainer 40.

The hood 60 is made of any suitable material, such as synthetic resin, formed in a square tubular form which covers the housing 20. A smaller diameter part 61 which snugly covers the outer periphery of the rear end part of the housing 20 is formed at the rear end part of the hood 60. A rear stop plate 62 extends across the rear face of the smaller diameter part 61. Window holes 63 through which the female terminal fittings may pass are formed in the rear stop plate 62 in correspondence with chambers 21.

Further, a locking arm 64 for locking with a corresponding male housing in a fitted condition is provided at a central position of an upper portion of the hood 60.

Hooking projections 65 are provided at the rear rims of the four faces of the housing 20 at central portions thereof. The rear side of the respective hooking projections 65 is tapered.

Hooking grooves 66 in which the hooking projections 65 can be fitted are formed in the walls of the hood 60 at positions corresponding to the four faces of the housing 20. When the rear of the housing 20 is fitted in the smaller diameter part 61 until it hits against the rear stop plate 62, the hooking projections 65 are fitted on the hooking grooves 66. Further, shallow escape grooves 67 are formed at the front side of the hooking grooves 66, and a tapered part 68 extends between them.

The present mode of operation is described below. As an example of the procedure of assembly, the packing 34 is first fitted at the fitting position 35 on the housing 20, and a collective stopper 30 is fitted in the stopper storing recess 25. Then, the retainer 40 is inserted in the retainer insertion hole 26 from the left side as viewed from the front, and assembled at the temporary locking position. In this condition, only the left half region of the front face of the chambers 21 is opened through each of terminal insertion openings 44 of the front stop plate 41 of the retainer 40, and the projections 46 are to the left side of the corresponding chambers 21. The retainer 40 also functions as a removal-stopper for the packing 34.

When the packing 34 and the stopper 30 are mounted against the housing 20 as described above and the retainer 40 is assembled at the temporary locking position, the rear end part of the housing 20 is inserted in the hood 60 from the front as shown in FIG. 15. The hooking projections 65 are pushed in while traversing along the escape grooves 67 and the rear end face is pushed in until it hits against the rear stop plate 62 of the hood 60. Each of the hooking projections 65 passes over the tapered part 68, is fitted in the hooking grooves 66 as shown in FIG. 16 and FIG. 17, and the housing 20 and the hood 60 are assembled. Additionally, the stopper 30 is retained in position by the rear stop plate 62. The assembly may be delivered to a location for the terminal insertion in such condition.

As shown in FIG. 16, the female terminal fittings 10 are provided in a position in which they face in opposite up and down directions for terminal insertion, and are inserted in the corresponding chambers 21 through the window holes 63 of the rear stop plate 62. Specifically, the female side terminal fittings 10 of the upper level are inserted in a position in which the stabilizers 14 are to the upper right as viewed from the insertion direction, and the stabilizers of those in the lower level are in a position to the lower left as viewed from the insertion direction.

As shown in FIG. 18, the marks 32 provided at the entrance rim of the electric wire insertion holes 31 can be viewed through the window holes 63 of the rear stop plate 62. Since the marks 32 are marked at the upper right position for the upper level electric wire insertion holes 31 and the marks 32 are marked at the lower left position for the lower level electric wire insertion holes 31, the female terminal fittings 10 can be inserted in the proper position by positioning the stabilizers 14 in alignment with the marks 32.

The female terminal fittings 10 are pushed in through the window holes 63 while spreading the electric wire insertion holes 31 of the stopper 30, and inserted in the corresponding chambers 21. They are pushed in while bending the lances 22 toward the bending space 23, and without being obstructed by the projections 46 of the retainer 40. When they are inserted in the proper position, the lances 22 return to their original positions, and are hooked on the barb portions 15 as shown in FIG. 19. Further, the inner peripheral face of the electric wire insertion holes 31 of the stoppers 30 grip the outer peripheral face of the electric wires W which were inserted.

When the insertion of the female terminal fittings 10 in the chambers 21 is complete, the continuity test for whether the respective female terminal fittings 10 are inserted in the proper chambers 21 is carried out. The continuity test is carried out while the retainer 40 is locked in the temporary locking position by contacting the test probe P of the testing equipment against the female terminal fittings 10 through the terminal insertion openings 44 of the front stop plate 41 of the retainer 40 as shown in FIG. 19.

As shown in FIG. 20, when the retainer 40 is in the temporary locking position, the terminal insertion openings 44 of the front stop plate 41 are offset to the left side, and only the left side region of the front face of the corresponding chambers 21 is in an opened condition. Therefore, the test probe P passed through the terminal insertion openings contacts the left side rim portion of the front of the connecting parts 12 of the female terminal fittings 10. Further, as shown in FIG. 3, in the upper level female terminal fittings 10, the rim side 12A is the rim side of the side on which the stabilizers 14 are provided, and in the lower level female terminal fittings 10, the rim side 12A is the rim side opposite the side on which the stabilizers 14 are provided. Accordingly, the test probe P is prevented from passing deeply into the connecting parts 12 and excessively bending the connecting pieces 11.

After the continuity test is complete, the connector is taken out from the test equipment and, the retainer 40 is moved to the final locking position. Specifically, a member, such as an operator's finger, engages the surface of the front stop plate 41 of the retainer 40, and the retainer 40 is moved to the right from the condition of FIG. 20. When the retainer 40 is moved to the final locking position as shown in FIG. 21, the final locking protrusion strips 53 are fitted in the locking groove 54 as described above, and retained in the final locking position. When the final locking protrusion strips 53 pass from the escape grooves 55 to the locking groove 54, they encounter resistance, but since the wrinkled face 48 is formed on the surface of the front stop plate 41, finger slipping is suppressed and the retainer 40 can be smoothly moved.

When the retainer 40 is moved to the final locking position, the projections 46 of the retainer 40 penetrate into the chambers 21, and are fitted in the hooked grooves 16 of the female terminal fittings 10 from the side. The female terminal fittings 10 are thus doubly locked in a no-slip condition. Further, the terminal insertion openings 44 of the front stop plate 41 are placed in a condition in which they are concentrically coordinated.

As illustrated above, according to the first mode of operation, since the front stop plate 41 is formed unitarily and in one piece, a user's finger or the like is touched on the front stop plate 41, and the moving operation of the retainer 40 can be easily carried out without using a jig.

Further, since the wrinkled face 48 is formed on the surface of the front stop plate 41, the wrinkles prevent finger sliding and the retainer 40 can be more smoothly inserted.

According to the description above, the assembly of the female waterproof connector in which the inlet side of the respective chambers 21 was sealed by the stopper 30 is completed. Then, when fit with the corresponding male connector, the female and male terminal fittings are mutually connected, the packing 34 is sandwiched between the female housing 20 and the corresponding male housing 20, and the gap between both housings is sealed.

As illustrated above, according to the present mode of operation, since the structure including the rear stop plate 62 to be mounted on the housing 20 is formed unitarily and in one piece with the hood 60, the number of parts of the connector is reduced, and the number of steps of assembly are reduced compared with a connector in which they are provided as separate bodies, therefore providing a large cost reduction.

Further, the retainer 40 of the present invention is the type that is inserted from the side of the housing 20 and directly locked on the female terminal fittings 10. Since the connector includes the housing 20 and the hood 60, the retainer 40 may be preliminarily placed at the temporary locking position against the housing 20 and pushed in the final locking position after being assembled with the hood 60. Therefore, it is unnecessary to provide an opening for mounting the retainer 40 in the hood 60.

The method of assembly in the above-mentioned mode of operation is one example, other methods such as, after preliminarily mounting a packing and a retainer, a collective stopper is fitted into final position, may be performed.

The present invention may also be similarly applied to a male waterproof connector which houses male terminal fittings.

A second embodiment of the present invention is described below with reference to FIG. 22 to FIG. 35. The non-waterproof female connector of the second embodiment includes a female housing 120, female terminal fittings 110 which are housed in the female housing 120, and a retainer 130 that locks the female terminal fittings 110 in a slip-stopping condition. The present invention may include any number of terminal fittings 110, and in the present embodiment, includes ten female terminal fittings 110.

As shown in FIG. 32, the female terminal fittings 110 have substantially square tubular connecting portions 111 which are configured to receive tab connecting portions of corresponding male terminal fittings therein. Female terminal fittings 110 are fixed on the terminal ends of electric wires W by crimping barrels 112 which are provided at the rear end thereof. Hooked grooves 114 on which the projections 138 of the retainer 130 can be fitted are formed at one side of the connecting portions 111. Lances 122 of housing 120 can be hooked on barb portions 115 of the rear rim at the same level.

The female housing 120 may be made of any suitable material, such as a synthetic resin, formed in a block form unitarily and in one piece, as shown in FIG. 22 to FIG. 25. The chambers 121 store the above-mentioned female terminal fittings 110 and open on the front and rear faces of housing 120 in two levels which each contain five chambers. The chambers 121 are symmetrically formed facing in opposite directions on the top and bottom levels. The lances 122 are respectively provided in a condition in which they can be elastically bent toward the upper face in the upper level of chambers 121 and toward the bottom face in the lower level of the chambers 121, facing toward the bending space 123 of the upper or lower level.

Accordingly, the female terminal fittings 110 are inserted in the chambers 121 from the rear (the right of FIG. 32) while elastically bending the lances 122. When the female terminal fittings 110 are inserted fully, the lances 122 are restored to their original position and are hooked on barb portions 115. Locking arm 125 for locking with a corresponding male connector housing (not illustrated) in a fitted condition is provided at an upper face of the female housing 120.

The retainer 130 is formed unitarily and in one piece and may be formed of any suitable material, such as a synthetic resin material, as shown in FIG. 26 to FIG. 28. The retainer 130 is provided with a front stop plate 131 which covers the front face of the chambers 121 in the female housing 120. The front stop plate 131 functions to stop the female terminal fittings 110 inserted in the chambers 121, while insertion openings 132 through which the tabs of the male terminal fittings may be inserted open at positions corresponding to the respective chambers 121.

An upper face plate 133 and a lower face plate 134 respectively constitute the front end part of the upper face of the upper level chambers 121 and the front end part of the bottom face of the lower level chambers 121 and extend from the rear face of the front stop plate 131. A cover plate 135 is formed at one side of the upper face plate 133 and the lower face plate 134.

From the edges of the above-mentioned upper face plate 133 and the lower face plate 134, long narrow insert portions 137 are formed at every position corresponding to each of the positions of the insertion openings 132. The respective insert portions 137 can penetrate into the bending space 123 beside the lances 122.

Further, at the inner faces of the upper face plate 133 and the lower face plate 134, projections 138 are formed in the central portion at every position corresponding to each of the positions of the insertion openings 132. The projections 138 can penetrate into the hooked grooves 114 of the above-mentioned female terminal fittings 110.

As shown in FIG. 24, the retainer insertion hole 140 into which the above-mentioned retainer 130 is inserted is formed at the front face of the female housing 120. The insertion hole 140 is formed in a sectional channel form which receives the front stop plate 131, the upper face plate 133 and the lower face plate 134. Further, top and bottom insertion grooves 141 respectively receive the insert portions 137 as they respectively penetrate the bending space 123. Additionally, second insertion grooves 142 can receive the projections 138 and correspond to the configurations of the upper face of the upper level chambers 121 and the bottom face of the lower level chambers 121, namely, positions corresponding to the hooked grooves 114 when the female terminal fittings 110 are properly inserted.

Further, recess 143 is formed at the front face of the retainer insertion hole 140 to meet the cover plate 135 of the retainer 130 in a snug fit.

The ribs 150 extend in the upper and lower directions and are formed at front rim positions on the upper face plate 133 and the lower face plate 134 of the retainer 130. The guide grooves 151, which receive the ribs 150, face the upper and lower directions and are formed on the upper face and the bottom face of the retainer insertion hole 140. On the left side position (FIG. 26) of the upper face plate 133 of the retainer 130, the temporary locking protrusion strips 152 and the final locking protrusions strips 153 are provided over the housing 120 on the inside of the ribs 150. On the other hand, as shown in FIG. 22, the locking grooves 154 to which the above-mentioned temporary locking protrusion strips 152 and the final locking protrusion strips 153 can be fitted are formed on the upper face of the retainer insertion hole 140. Further, escape grooves 155 which fit the temporary locking protrusion strips 152 and the final locking protrusion strips 153 to allow for escape are formed at both sides of the locking grooves 154.

When the retainer 130 is inserted in the retainer insertion hole 140, the temporary locking protrusion strips 152 are first fitted in the locking grooves 154 and retained as shown in FIG. 29, and this becomes the temporary locking position of the retainer 130. Further, when the retainer 130 is pushed in, the final locking protrusion strips 153 are fitted in the locking grooves 154 and retained as shown in FIG. 33, and this becomes the final locking position.

When the retainer 130 is situated at the temporary locking position, the cover plate 135 projects from the side face of the female housing 120, the respective insert portions 137 are offset to one side (the left side of FIG. 31) in the width direction of the bending space 123, and the respective projections 138 are similarly in a position in which they are offset to one side in the width direction of the corresponding chambers 121.

On the other hand, when the retainer 130 is situated at the final locking position, the cover plate 135 is placed in the recess 143 of the female housing 120, and as shown in FIG. 34, the respective insert portions 137 project into the bending space 123, and the respective projections 138 project into the corresponding chambers 121.

Further, as shown in FIG. 26, a wrinkled face 139 is formed on the surface of the front stop plate 131 of the retainer 130. The wrinkled face 139 indicates an uneven rough face. The wrinkled face 139 is formed, for example, by forming a wrinkled pattern on the molding face of a mold on which the surface of the front stop plate 131 is molded, in the mold for the retainer 130.

The mode of operation of the second embodiment is described below. As an example of the assembly procedure, the retainer 130 is first inserted in the retainer insertion hole 140, and assembled to the temporary locking position as shown in FIG. 29 and FIG. 30. In this condition, as shown in FIG. 31 and FIG. 32, the respective insert portions 137 of the retainer 130 are offset to one side in the width direction of the bending space 123, and the respective projections 138 are offset to one side in the width direction of the corresponding chambers 121. Further, the front stop plate 131 of the retainer 130 blocks the front face of the chambers 121 in a condition offset from the insertion openings 132.

As shown in FIG. 32, the female terminal fittings 110 are provided in a position in which they face in opposite up and down directions, and are inserted in the corresponding chambers 121. The female terminal fittings 110 are pushed in while elastically bending the lances 122 toward the bending space 123 and without being obstructed by the projections 138 of the retainer 130. When the female terminal fittings 110 are inserted in the final position, the lances 122 are restored to their original position and are locked in the slip-stopping condition by being locked on the barb portions 115 (refer to FIG. 35).

When the female terminal fittings 110 are completely inserted in the chambers 121, the retainer 130 is pushed in the final locking position as shown in FIG. 33. When the retainer 130 is pushed in the final locking position, the projections 138 of the retainer 130 project into the chambers 121 and are fitted on the hooked grooves 114 of the female terminal fittings 110. Further, the insert portions 137 of the retainer 130 are inserted into the bending space 123, and the bending deformation of the lances 122 is controlled. Therefore, the female terminal fittings 110 are prevented from being pulled out while elastically bending the lances 122.

The female terminal fittings 110 are doubly and triply hooked by the retainer 130 in addition to the lances 122 in the slip-stopping condition. Further, the insertion openings 312 of the front stop plate 131 are placed in a condition in which they are concentrically coordinated, in front of the respective chambers 121.

When the female terminal fittings 110 are pulled out from the female housing 120 for maintenance or the like, the retainer 130 is pulled out from the final locking position, skipping the temporary locking position. Thus, since the front of the lances 122 are released, the lock is removed by forcing the lances 122 to bend against the bending space 123 by a jig or the like, and the female terminal fittings 110 are pulled out of the rear of the chambers 121.

Hereby, when the above-mentioned retainer 130 is pulled out, the front stop plate 131 is released and placed in front of the female housing 120. Therefore, the retainer 130 can be removed without using a jig by touching a finger on the surface of the front stop plate 131 and moved in the left direction of FIG. 33. In particular, since the wrinkled face 139 is formed on the surface of the front stop plate 131, the wrinkles function as a hook, finger sliding is prevented, and the retainer 130 can be smoothly removed.

The present invention is not limited to the modes of operation which were illustrated by the above-mentioned description and drawings, and for example, the following modes of operation are also included in the technical scope of the present invention. Further, the present invention can be performed by providing changes in addition to the descriptions below.

The present invention can be also similarly applied to a waterproof connector in which the connector housing is formed unitarily and in one piece.

The retainer in the second embodiment may be a retainer in which the insert portions are eliminated.

A third embodiment of the present invention is illustrated below based on FIGS. 36-41.

The third embodiment includes a front retainer type male waterproof connector. The connector of the third embodiment is provided with the male connector housing 210, the male terminal fittings 201 which are housed in the male housing 210, and the front type retainer 220 for doubly hooking the male terminal fittings 201 as shown in FIGS. 36 and 37.

The male housing 210 is formed unitarily and in one piece from any suitable material, such as a synthetic resin material, and has a form in which a hood portion 212 is formed to surround the front half portion of the flat tower portion 211. The front half portion of the tower portion 211 is separated into two, and the chambers 213 in which the male terminal fittings 201 can be inserted are provided side by side in parallel along a horizontal direction, in accordance with the separation. At the bottom faces of the respective chambers 213, lances 214 which can be hooked on the barb portions 203 of the male terminal fittings 201 are provided adjacent the lower bending space 215 such that the lances 214 may be elastically bent, and the front portions of the lances 214 at the bottom faces of the chambers 213 are freely movable and open.

In the separated front half portion of the respective chambers 213, guide slots 217 which face in forward and rearward directions are provided at the respective left and right side walls by penetrating the wall faces, the rear ends are opened to the back half portion at which the diameters of the chambers 213 are expanded, and the front ends are closed.

Further, the male terminal fittings 201, which are crimped on the terminals of electric wires W, are inserted in the corresponding chambers 213 from the rear (the left side of FIG. 37), the stabilizers 202 are pushed in along the guide slots 217 and the lances 214 are elastically bent by the male terminal fittings 1 on the way. When the male terminal fittings 201 are pushed to the final position, the lances 214 are restored to their original position and are fitted on the barb portions 203. Accordingly, the male terminal fittings 201 are primarily hooked in a condition in which they extend into the hood portion 212, and stoppers 205 fitted on the rear of the male terminal fittings 1 close and seal the inlet of the chambers 213. The stoppers 205 may be formed of any suitable material, such as rubber.

At the front face of the above-mentioned tower 211, the retainer 220 for doubly locking the male terminal fittings 201 may be inserted from the opening side of the hood portion 12 and mounted therein. The retainer 220 may be formed of any suitable material, such as a synthetic resin material. The retainer 220 may be fitted into the inner periphery of the hood portion 212, and can be fixed on the front end of the tower portion 211.

On the inside of the retainer 220, two fitting holes 221, which are fitted on the outside of respective separated portions of the above-mentioned tower portion 211, are formed on the left and right, sandwiching the partition wall 222 therebetween. Projecting portions 223 are formed at the rear sides (the right side of FIG. 37) in the insertion direction on the bottom faces of respective fitting holes 221 so as to form the lower walls of the front end parts of the chambers 213. Further, the lower walls of the rear end side in the insertion direction in the retainer 220 form the insert portions 224 which are inserted in the bending spaces 215 adjacent the above-mentioned lances 214.

At side faces of the respective fitting holes 221, final locking projections 225 are provided projecting into the fitting holes 21 at a position which is situated slightly rearward of the central portion in the insertion direction, and the front rims of the separated guide grooves 217 provided in the above-mentioned chambers 213 are the locking rims 217A to which the above-mentioned final locking projections 225 are hooked.

Further, at the central portions on the ceiling faces of the fitting holes 221, ribs 227 which extend from the back rim toward the front rim are provided, and temporary locking projections 228 are provided at the edges of the ribs 227 and extending downward. On the other hand, sliding grooves 218 extending from the front rim in the forward and rearward directions are notched into the upper faces of chambers 213. The above-mentioned temporary locking projections 228 are designed to be slidably fitted and the locking parts 218A to which the temporary locking projections 228 are locked are formed on the front rims of the sliding grooves 218.

Then, in the present mode of operation, the wrinkled face 230 is provided on the front face of the retainer 220 as shown in FIG. 36. The wrinkled face 230 is molded by forming a wrinkle pattern on the molding face on which the front face of the retainer 220 is molded, in the mold of the retainer 220.

Further, the other surface in the retainer 220 and the entire surface of the male housing 210 are formed as a usual flat face. The flat face is molded by finishing the molding face of the mold as a mirror face.

Successively, the action of the present mode of operation is illustrated. As shown by the arrow of FIG. 37, when the retainer 220 is inserted in the hood portion 212 of the male housing 210 from the front, the temporary locking projections 228 are locked on the locking parts 218A of the sliding grooves 218, and the final locking projections 225 abut the front face of the tower portion 211. Therefore, the retainer 220 is temporarily retained at the temporary locking position. At the temporary locking position, the insert portions 224 of the retainer 220 are held away from the bending spaces 215 adjacent the lances 214, and the elastic bending of the lances 214 is allowed.

The connector is delivered to the working area for terminal insertion in a condition in which the retainer 220 is installed at the temporary locking position, and confirmation whether the retainer 220 is properly mounted or not is possible and may be performed at the working area before the male terminal fittings 201 are inserted. In this case, the inner side of the hood portion 212 of the male housing 210 is covered, but since the front face of the retainer 220 includes the wrinkled face 230 and can be visually differentiated from the flat face as shown in FIG. 38, it can be judged whether the retainer 220 is properly mounted. To the contrary, when the difference between the surfaces cannot be visually confirmed, the retainer 220 is not properly mounted.

When the mounting of the retainer 220 can be confirmed as described above, the male terminal fittings 201 are inserted in the corresponding chambers 213 from the rear as shown by the arrow of FIG. 39, and when they are pushed into the final position, they are locked by the lances 214 to be housed as shown in FIG. 40.

Then, when the retainer 220 is pushed to the final locking position which is shown in FIG. 41, the final locking projections 225 are hooked on the hooking rims 217A of the guide slots 217 and mounted in a slip-stopping condition, the insert portions 224 of the retainer 220 are inserted into the bending spaces 215, and the lances 214 are prevented from being further bent, therefore the male terminal fittings 201 are doubly hooked in the slip-stopping condition.

According to the present mode of operation, since the wrinkled face 230 is formed on the front face of the retainer 220, visual confirmation can be carried out by discerning it from the flat face of the surrounding wall face. Therefore, proper mounting of the retainer 220 can be easily discerned.

The molding of the above-mentioned wrinkled face 230 can be formed by forming a wrinkled pattern on the corresponding molding face in the mold, and the male housing 210 and the retainer 220 can be molded using the same resin material, therefore they can be produced at low cost.

Further, when the wrinkle faced 230 is also molded for the side peripheral face of the retainer 220, the unwrinkled face 230 acts as and in the case of sandwiching the retainer 220 and inserting it into the hood portion 212 of the male housing 210, it hardly slides, therefore the insertion work is easily performed.

Further, the above-mentioned male housing 210 and retainer 220 can be formed by in-mold assembly. For example, the male housing 210 and the retainer 220 are molded at another location (a position offset from the axis of assembly here) of the same mold, both are concentrically located after opening the mold, the retainer 220 is pushed into the hood portion 212 of the male housing 210 by the mold-moving mechanism, both are assembled to the temporary locking position, and a product is taken out in such condition.

Since this method also forms the molding face as the wrinkled pattern of the retainer 220, the wrinkled face 230 can be molded, and therefore visual confirmation can be carried out by discerning it from the surrounding flat face of the hood portion 212 of the male housing 210. Namely, the proper mounting of the retainer 220 can be easily confirmed for the connector formed by the in-mold assembly.

As an alternative, the connector housing may be formed with a wrinkled pattern from a wrinkle molding, and the retainer may be formed from a conventional molding.

The retainer of the present invention is not limited to the front type described above, but may be a side retainer type of retainer to be inserted from the side of the connector housing and directly hooked on the terminal fittings, and other types.

The present invention can be similarly applied to a female connector.

Although the invention has been described with reference to an exemplary embodiment, it is understood that the words that have been used are words of description and illustration, rather than words of limitation. Changes may be made, within the purview of the appended claims, as presently stated and as amended, without departing from the scope and spirit of the present invention in its aspects. Although the invention has been described herein with reference to particular means, materials and embodiments, the invention is not intended to be limited to the particulars disclosed herein. Instead, the invention extends to all functionally equivalent structures, methods and uses, such as are within the scope of the appended claims.

The present disclosure relates to subject matter contained in priority Japanese Application Nos. 2000-387719 filed on Dec. 20, 2000; 2000-401434 and 2000-401956, both filed on Dec. 28, 2000, the disclosures of which are herein expressly incorporated by reference in their entireties.

What is claimed is:

1. A connector comprising:
a connector housing having a plurality of chambers therein in which terminal fittings are provided;
a retainer for preventing movement of the terminal fittings, said retainer being received in a front end of said connector housing and configured to be retained in said connector housing at a temporary locking position allowing insertion and extraction of the terminal fittings into and out of said chambers and a final locking position preventing movement of the terminal fittings within said chambers; and
a front stop plate configured to prevent movement of the terminal fittings within said chambers when said retainer is positioned in said final locking position, said front stop plate being formed unitarily and in one piece with said retainer.

2. The connector according to claim 1, wherein said front stop plate includes a wrinkled surface.

3. The connector according to claim 1, further comprising:
a plurality of temporary locking strips provided on an upper face and a lower face of said connector housing and extending from the front end toward a rear end of said connector housing;
a plurality of final locking strips provided on the upper face and the lower face of said connector housing and extending from the front end toward the rear end of said connector housing; and
a plurality of locking grooves provided on an upper face and a lower face inside said retainer and extending from a front end toward a rear end of said retainer;
wherein said plurality of locking grooves can be fitted to said plurality of temporary locking strips to position said retainer in said temporary locking position, said plurality of locking grooves can be fitted to said plurality of final locking strips to position said retainer in said final locking position, and said retainer can be moved relative to said connector housing in a transverse direction between said temporary locking position and said final locking position.

4. The connector according to claim 1, further comprising:
a plurality of projections provided on a ceiling wall plate and a bottom wall plate in said retainer;
wherein said plurality of projections are offset to corresponding chambers in said connector housing when said retainer is positioned in said temporary locking position, said plurality of projections extend into said chambers in said connector housing and grooves in the terminal fittings therein when said retainer is positioned in said final locking position, and said retainer can be moved relative to said connector housing in a transverse direction between said temporary locking position and said final locking position.

5. A method of assembling a connector comprising:
providing a connector housing having a plurality of chambers for receiving terminal fittings therein;
providing a retainer for preventing movement of the terminal fittings,
assembling said retainer and said connector housing such that said retainer is received in a front end of said connector housing and said retainer may be retained in said connector housing at a temporary locking position allowing insertion and extraction of the terminal fittings into and out of said chambers and a final locking position preventing movement of the terminal fittings within said chambers; and
providing a front stop plate, said front stop plate configured to prevent movement of the terminal fittings within said chambers when said retainer is positioned in said final locking position, said front stop plate being formed unitarily and in one piece with said retainer.

6. The method of assembling a connector according to claim 5, wherein said front stop plate includes a wrinkled surface.

7. The method of assembling a connector according to claim 5, further comprising:
providing a plurality of temporary locking strips on an upper face and a lower face of said connector housing and extending from the front end toward a rear end of said connector housing;
providing a plurality of final locking strips on the upper face and the lower face of said connector housing and extending from the front end toward the rear end of said connector housing;
providing a plurality of locking grooves on an upper face and a lower face inside said retainer and extending from a front end toward a rear end of said retainer, wherein said plurality of locking grooves can be fitted to said plurality of temporary locking strips to position said retainer in said temporary locking position, and said plurality of locking grooves can be fitted to said plurality of final locking strips to position said retainer in said final locking position; and
moving said retainer relative to said connector housing in a transverse direction between said temporary locking position and said final locking position.

8. The method of assembling a connector according to claim 5, further comprising:
providing a plurality of projections on a ceiling wall plate and a bottom wall plate in said retainer, wherein said plurality of projections are offset to corresponding chambers in said connector housing when said retainer is positioned in said temporary locking position, and said plurality of projections extend into said chambers in said connector housing and grooves in the terminal fittings therein when said retainer is positioned in said final locking position; and
moving said retainer relative to said connector housing in a transverse direction between said temporary locking position and said final locking position.

9. The connector according to claim 1, further comprising:
a plurality of lances provided on the inside of said connector housing, said plurality of lances extending toward the front face of said connector housing and being configured to be elastically bent into bending spaces adjacent said lances and hooked onto barb portions of the terminal fittings; and
a plurality of insert portions provided on said retainer and extending toward a rear end of said retainer, said insert portions being configured to extend into said bending spaces.

10. The method of assembling a connector according to claim 5, further comprising:
providing a plurality of lances on the inside of said connector housing, said plurality of lances extending toward the front face of said connector housing and being configured to be elastically bent into bending spaces adjacent said lances and hooked onto barb portions of the terminal fittings;
providing a plurality of insert portions on said retainer extending toward a rear end of said retainer; and
said assembling said retainer and said connector housing includes:
inserting the terminal fittings into said chambers, thereby bending said lances into said bending spaces; and
inserting said insert portions into said bending spaces.

11. The method of assembling a connector according to claim 10, wherein said plurality of insert portions are offset to corresponding chambers in said connector housing when said retainer is positioned in said temporary locking position, and said plurality of insert portions extend into said bending spaces when said retainer is positioned in said final locking position, said method further comprising:
moving said retainer relative to said connector housing in a transverse direction between said temporary locking position and said final locking position, thereby inserting said plurality of insert portions into corresponding said bending spaces.

12. A waterproof connector comprising:
a connector housing having a plurality of chambers in which terminal fittings are provided;
a hood, said hood being assembled with said connector housing and covering an outer surface thereof;
a stopper storing recess provided at a rear face of said connector housing, said stopper storing recess configured to receive a collective stopper;
a collective stopper mounted in said stopper storing recess over said rear face of said connector housing and covering said plurality of chambers; and
a rear stop plate provided on said hood, said rear stop plate being configured to press said collective stopper.

13. The waterproof connector according to claim 12 further comprising:
a retainer for preventing movement of terminal fittings inserted in said chambers, said retainer being mounted in a front end of said connector housing and being configured to be retained in said connector housing at a temporary locking position allowing insertion and extraction of the terminal fittings into and out of said chambers and a final locking position preventing movement of the terminal fittings within said chambers.

14. A connector comprising:
a connector housing configured to receive terminal fittings; and
a retainer configured to stop movement of terminal fittings within said connector housing, said retainer being assembled with said connector housing; and
a wrinkled molding provided on the surface of one of said connector housing and said retainer.

15. The connector according to claim 14, wherein said connector housing includes a plurality of chambers to receive the terminal fittings, and wherein said retainer is configured to be retained in said connector housing at a temporary locking position allowing insertion and extraction of the terminal fittings into and out of said connector housing and a final locking position preventing movement of the terminal fittings.

16. The connector according to claim 14, wherein said connector housing and said retainer are molded in one mold such that said retainer may be removed by a moving mechanism from the mold in a condition in which it is assembled with said connector housing in said temporary locking position.

17. The connector according to claim 14, wherein said retainer is received in a front end of said connector housing, further comprising:
a plurality of lances provided on the inside of said connector housing, said plurality of lances extending toward the front face of said connector housing and being configured to be elastically bent into bending spaces adjacent said lances and hooked onto barb portions of the terminal fittings; and
a plurality of insert portions provided on said retainer and extending toward a rear end of said retainer, said insert portions being configured to extend into said bending spaces.

18. The connector according to claim 14, wherein said connector housing further comprises:
a tower portion including a plurality of chambers therein, each chamber of said plurality of chambers configured to receive a male terminal fitting therein; and
a hood portion configured to receive said retainer therein.

19. The connector according to claim 14, further comprising:
a plurality of chambers provided in said connector housing, said chambers configured to receive terminal fittings therein; and
said retainer being received in a front end of said connector housing and configured to be retained in said connector housing in a temporary locking position allowing insertion and extraction of the terminal fittings into and out of said chambers and a final locking position preventing movement. of the terminal fittings within said chambers.

20. The connector according to claim 19, further comprising:
a plurality of temporary locking projections provided on the inside of said retainer and extending from a front end of said retainer toward a rear end of said retainer;
a plurality of final locking projections provided on the inside of said retainer and extending transversely from the sides of said retainer;
a plurality of sliding grooves provided on the inside of said plurality of chambers in said connector housing and extending from a front end of said connector housing toward a rear end of said connector housing and a plurality of locking parts provided at a rear end of said sliding grooves; and
a plurality of guide slots provided on the inside of said plurality of chambers in said connector housing and extending from a front end of said connector housing toward a rear end of said connector housing and a plurality of locking rims provided at a rear end of said guide slots;
wherein said plurality of temporary locking projections can be locked onto corresponding locking parts to position said retainer in said temporary locking position, and said plurality of final locking projections can be locked onto corresponding said locking rims to position said retainer in said final locking position, and said retainer can be moved relative to said connector housing in a forward direction between said temporary locking position and said final locking position.

21. The connector according to claim 19, further comprising:
a plurality of lances provided on the inside of said connector housing, said plurality of lances extending toward the front face of said connector housing and being configured to be elastically bent into bending spaces adjacent said lances and hooked onto barb portions of the terminal fittings; and
a plurality of insert portions provided on said retainer and extending toward a rear end of said retainer, said insert portions being configured to extend into said bending spaces when said retainer is positioned in said final locking position.

22. A method of assembling a connector comprising:
providing a connector housing configured to receive terminal fittings;
providing a retainer configured to prevent movement of terminal fittings within said connector housing;
assembling said retainer with said connector housing; and
providing a wrinkled molding on the surface of one of said connector housing and said retainer.

23. The method of assembling a connector according to claim 22, wherein said connector housing includes a plurality of chambers to receive the terminal fittings, and wherein said retainer is configured to be retained in said connector housing at a temporary locking position allowing insertion and extraction of the terminal fittings into and out of said connector housing and a final locking position preventing movement of the terminal fittings.

24. The method of assembling a connector according to claim 22, further comprising:
molding said connector housing and said retainer in one mold such that said retainer may be removed by a moving mechanism from the mold in a condition in which said retainer is assembled with said connector housing in said temporary locking position.

25. The method of assembling a connector according to claim 22, wherein said retainer is received in a front end of said connector housing, further comprising:
providing a plurality of lances on the inside of said connector housing, said plurality of lances extending toward the front face of said connector housing and being configured to be elastically bent into bending spaces adjacent said lances and hooked onto barb portions of the terminal fittings; and
providing a plurality of insert portions on said retainer and extending toward a rear end of said retainer, said insert portions being configured to extend into said bending spaces.

26. The method of assembling a connector according to claim 22, further comprising:
providing a plurality of chambers in said connector housing, said chambers configured to receive terminal fittings therein; and
said retainer being received in a front end of said connector housing and configured to be retained in said connector housing in a temporary locking position allowing insertion and extraction of the terminal fittings into and out of said chambers and a final locking position preventing movement of the terminal fittings within said chambers.

27. The method of assembling a connector according to claim 26, further comprising:
providing a plurality of temporary locking projections on the inside of said retainer and extending from a front end of said retainer toward a rear end of said retainer;
providing a plurality of final locking projections on the inside of said retainer and extending transversely from the sides of said retainer;
providing a plurality of sliding grooves on the inside of said plurality of chambers in said connector housing and extending from a front end of said connector housing toward a rear end of said connector housing and a plurality of locking parts provided at a rear end of said sliding grooves; and
providing a plurality of guide slots on the inside of said plurality of chambers in said connector housing and extending from a front end of said connector housing toward a rear end of said connector housing and a plurality of locking rims provided at a rear end of said guide slots;
wherein said plurality of temporary locking projections can be locked onto corresponding locking parts to position said retainer in said temporary locking position, and said plurality of final locking projections can be locked onto corresponding said locking rims to position said retainer in said final locking position, and said retainer can be moved relative to said connector housing in a forward direction between said temporary locking position and said final locking position.

28. The method of assembling a connector according to claim 26, further comprising:
providing a plurality of lances on the inside of said connector housing, said plurality of lances extending toward the front face of said connector housing and being configured to be elastically bent into bending spaces adjacent said lances and hooked onto barb portions of the terminal fittings; and
providing a plurality of insert portions on said retainer and extending toward a rear end of said retainer, said insert portions being configured to extend into said bending spaces when said retainer is positioned in said final locking position.
